(19) United States
(12) Patent Application Publication
(10) Pub. No.: US 2026/0213841 A1
(43) Pub. Date: Jul. 23, 2026

(54) Fast Acquisition Laser Communications using a Hybrid Shift Process

(71) Applicant: The Boeing Company, Arlington, VA (US)

(72) Inventor: Nathan D. Hiller, Irvine, CA (US)

(21) Appl. No.: 19/027,322

(22) Filed: Jan. 17, 2025

(51) Int. Cl. H04B 10/118; H04B 10/50

(52) U.S. Cl. CPC H04B 10/118; H04B 10/503

(57) ABSTRACT

A method converges a laser beam. A sequence of shifts is identified from a simulation of sequences of shifts that move an average distance of test points from a center of a test quad cell sensor to reach a convergence on the test quad cell sensor, wherein a shift in the sequence of shifts after a prior shift in the sequence of shifts is based on a starting quad from which the prior shift occurs and a subsequent quad in which a detection occurs in a quad cell sensor in response to the prior shift. A position of a mirror receiving the laser beam is changed using the sequence of shifts to converge on the center of the quad cell sensor.

### CROSS-REFERENCE TO RELATED APPLICATIONS

This application is related to the following

U.S. Patent Applications: U.S. Patent Application Ser. No. ______, Attorney Docket No. 24-1492-US-NP, filed even date hereof, and entitled “Fast Acquisition Laser Communications using a Variable Binary Shift Process;” U.S. Patent Application Ser. No. ______, Attorney Docket No. 24-1492-US-NP[2], filed even date hereof, and entitled “Fast Acquisition Laser Communications using a Split Variable Shift Process;” and U.S. Patent Application Ser. No. ______, Attorney Docket No. 24-1492-US-NP[3], filed even date hereof, and entitled “Fast Acquisition Laser Communications using a Minimum Average Distance Shift Process;” which are incorporated herein by reference in their entirety.

### STATEMENT OF GOVERNMENT INTEREST

This invention was made with United States

Government support. The United States Government has certain rights in the invention.

### BACKGROUND INFORMATION

### 1. Field

The present disclosure relates generally to communications and in particular, to communications using laser beams.

### 2. Background

Communication at high data rates between communications terminals can be laser based. These terminals can include platforms such as satellites, ground stations, vehicles, ships, aircraft, and high altitude platform systems (HAPSs). Data is transmitted using laser beams that enable high speed low latency data communications. These laser beams are used to form line of sight communications links.

The establishment of these laser based communications links involve precisely pointing the laser beams at the communications terminals. For example, a communications terminal such as a satellite receives a laser beam from a transmitter communications terminal, such as a space station, aircraft, a ground station or other type of communications terminal that can transmit a laser beam. This laser beam is reflected by a mirror in the satellite receiving the laser beam to a quad cell sensor in the satellite.

The quad cell sensor measures intensity of the laser beam in each quadrant of the sensor. The mirror can be moved or rotated to adjust the angle of the mirror to steer the laser beam towards a desired alignment. In this case, the desired alignment occurs in response to detecting an equal intensity at each of the quadrants.

To determine the position of the transmitter communications terminal relative to the satellite, the satellite analyzes where the laser beam hits the quad-cell sensor. The mirror at the satellite is rotated incrementally to shift the laser beam's point of contact on the quad cell sensor towards the center of the quad cell sensor. The sensor detects the direction and magnitude of the laser beam's displacement, providing data on where the laser beam is detected with respect to the center of the quad cell sensor. These measurements correspond to the angular adjustments made by the mirror, which are directly related to the relative positioning of the transmitter communications terminal.

A direction of the laser beam can be used to determine the position of the transmitter terminal by mapping the relationship between mirror rotation angles and where the laser beam is detected on the quad cell sensor. A model of the optical geometry, including the distances and angles involved, can be used to calculate spatial coordinates for the transmitter communications terminal. This iterative process of mirror adjustment and feedback analysis is used to determine the position of the transmitter communications terminal relative to the satellite.

Once the position of the transmitter communications terminal is known, a return laser beam can be transmitted by the satellite to the transmitter communications terminal. This return laser vision is transmitted as part of the acquisition process to establish the communications link between the satellite and the transmitter communications terminal.

### SUMMARY

An embodiment of the present disclosure provides a method for converging a laser beam. A sequence of shifts is identified from a simulation of sequences of shifts that move an average distance of test points from a center of a quad cell sensor to reach a convergence on a test quad cell sensor, wherein a shift in the sequence of shifts after a prior shift in the sequence of shifts is based on a starting quad from which the prior shift occurs and a subsequent quad in which a detection occurs in the quad cell sensor in response to the prior shift. A position of a mirror receiving the laser beam is changed using the sequence of shifts to converge on the center of the quad cell sensor.

Another embodiment of the present disclosure provides a communications terminal comprising a quad cell sensor, a mirror, and a communications controller. The mirror directs a laser beam received by the communications terminal to the quad cell sensor. The communications controller is configured to perform operations comprising identifying a sequence of shifts from a simulation of sequences of shifts that move an average distance of test points from a center of a test quad cell sensor to reach a convergence on the test quad cell sensor, wherein a shift in the sequence of shifts after a prior shift in the sequence of shifts is based on a starting quad from which the prior shift occurs and a subsequent quad in which a detection occurs in the quad cell sensor in response to the prior shift and changing a position of a mirror receiving the laser beam using the sequence of shifts to converge on the center of the quad cell sensor.

Still another embodiment of the present disclosure provides a computer program product for converging a laser beam. The computer program product comprising a set of one or more computer-readable storage media and program instructions stored on the set of one or more storage media to perform operations comprising identifying a sequence of shifts from a simulation of sequences of shifts that move an average distance of test points from a center of a test quad cell sensor to reach a convergence on the test quad cell sensor, wherein a shift in the sequence of shifts after a prior shift in the sequence of shifts is based on a starting quad from which the prior shift occurs and a subsequent quad in which a detection occurs in a quad cell sensor in response to the prior shift; and changing a position of a mirror receiving the laser beam using the sequence of shifts to converge on the center of the quad cell sensor.

The features and functions can be achieved independently in various embodiments of the present disclosure or may be combined in yet other embodiments in which further details can be seen with reference to the following description and drawings.

### BRIEF DESCRIPTION OF THE DRAWINGS

The novel features believed characteristic of the illustrative embodiments are set forth in the appended claims. The illustrative embodiments, however, as well as a preferred mode of use, further objectives and features thereof, will best be understood by reference to the following detailed description of an illustrative embodiment of the present disclosure when read in conjunction with the accompanying drawings, wherein:

FIG. 1 is an illustration of a pictorial representation of a communications network in which illustrative embodiments may be implemented;

FIG. 2 is an illustration of a block diagram of a communications environment in accordance with an illustrative embodiment;

FIG. 3 is an illustration of shifting of the laser beam in accordance with an illustrative embodiment;

FIG. 4 is an illustration of a shift sequence in accordance with an illustrative embodiment;

FIG. 5 is an illustration of a simulation of shifts for a laser beam in accordance with an illustrative embodiment;

FIG. 6 is an illustration of a simulation of shifts for a laser beam in accordance with an illustrative embodiment;

FIG. 7 is an illustration of a simulation of shifts for a laser beam in accordance with an illustrative embodiment;

FIG. 8 is an illustration of a simulation of shifts for a laser beam in accordance with an illustrative embodiment;

FIG. 9 is an illustration of a tree structure in accordance with an illustrative embodiment;

FIG. 10 is an illustration of a flowchart of a process for converging a laser beam in accordance with an illustrative embodiment;

FIG. 11 is an illustration of a flowchart of a process for simulating a sequence of shifts for a laser beam in accordance with an illustrative embodiment;

FIG. 12 is an illustration of a flowchart of a process for converging a laser beam in accordance with an illustrative embodiment;

FIG. 13 is an illustration of a flowchart of a process for simulating a shift for a laser beam in accordance with an illustrative embodiment;

FIG. 14 is an illustration of a flowchart of a process for converging a laser beam in accordance with an illustrative embodiment;

FIG. 15 is an illustration of a flowchart of a process for simulating a shift for a laser beam in accordance with an illustrative embodiment;

FIG. 16 is an illustration of a flowchart of a process for converging a laser beam in accordance with an illustrative embodiment;

FIG. 17 is an illustration of a flowchart of a process for simulating a shift for a laser beam in accordance with an illustrative embodiment;

FIG. 18 is an illustration of a flowchart of a process for simulating shifts of a laser beam in accordance with an illustrative embodiment; and

FIG. 19 is an illustration of a block diagram of a data processing system in accordance with an illustrative embodiment.

### DETAILED DESCRIPTION

The illustrative embodiments recognize and take into account one or more different considerations as described herein. High data rate communications employ the use of precisely pointed laser beams. Long distances separate communications terminals such as ground stations, mobile vehicles, maritime, aviation, high altitude platform systems (HAPS), satellites, and other types of receivers.

The initial acquisition using laser beams for communications links involves having at least one of the laser beams scan an uncertainty area as quickly as possible. An uncertainty area is an area in which a receiver is expected to be present. However, the scanning needs to be slow enough for the receiving communications terminal to detect the laser beam. Beam scan time is longer than desired. For example, the amount of time to scan and acquire a satellite can be 100 seconds. In many cases, the scanning can take 10 seconds. However, it is desirable to reduce the amount of time as much as possible to increase the speed at which communications can be established between different communications terminals.

As part of establishing communications, a receiver detects a laser beam and determines the origination of the laser beam. This information is used to send a return laser beam as part of establishing communications between the two communications terminals.

A detector such as a quad cell detector in conjunction with the position of a mirror steering the laser beam received from a source towards the quad cell detector is used to determine the location of the source. This detector is a sensor divided into four quadrants. The quadrants are also referred to as quads. The division into quads is used to track signal strength variations and adjust the mirror positioning.

The laser beam is shifted by the mirror to obtain quad cell convergence. By comparing the signal intensity across the quadrants, the changes in the direction of the laser beam from the mirror can be made to shift the laser beam at the center of the four quad cells. The iterative process for convergence minimizes errors. In this illustrative example, the direction of the incoming laser beam can be detected on the sixth detection after five shifts of the incoming laser beam by the mirror.

The illustrative examples provide a method, apparatus, system, and computer program product for converging a laser beam on a quad cell sensor. The illustrative examples provide a number of methods for converging a laser beam in a manner that provides for convergence within five shifts of the laser beam. This convergence can be a convergence on the center of the quad cell sensor or within some threshold distance from the center of the quad cell sensor.

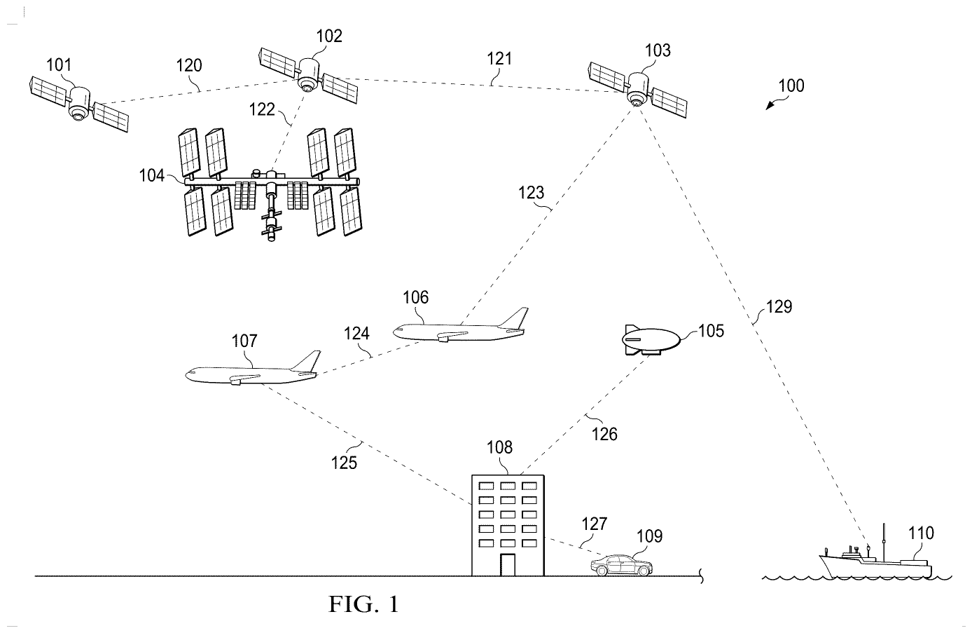

With reference now to the figures and, in particular, with reference to FIG. 1, an illustration of a pictorial representation of a communications network is depicted in which illustrative embodiments may be implemented. In this example, communications network 100 includes a number of communications terminals. As depicted, these communications terminals are satellite 101, satellite 102, satellite 103, space station 104, high altitude platform system (HAPS) 105, airplane 106, airplane 107, building 108, car 109, and surface ship 110.

As used herein, “a number of” when used with reference to items, means one or more items. For example, a number of communications terminals is one or more communications terminals.

These different communications terminals exchange information using communications links. In this example, satellite 101 and satellite 102 exchange information using communications link 120. Satellite 102 and satellite 103 communicate using communications link 121. Satellite 102 also communicates with space station 104 using communications link 122.

Further in this example, satellite 103 communicates with airplane 106 using communications link 123 and with surface ship 110 using communications link 129. Communications link 124 provides communications between airplane 106 and airplane 107. In this example, airplane 107 also communicates with building 108 using communications link 125.

High altitude platform system (HAPS) 105 communicates with building 108 using communications link 126. Building 108 communicates with car 109 using communications link 127.

In this example, these communications links are high-speed communications links in the form of laser beams. The communications links can be unidirectional or bidirectional. Each direction of communications involves a laser beam being transmitted from one communications terminal to another communications terminal. The communications terminal transmitting the laser beam is referred to as a transmitter communications terminal, and the communications terminal receiving the laser beam is referred to as the receiver communications terminal.

In these examples, increasing the speed at which communications links can be established can improve the speed at which data transmissions can occur. Receivers in these communications terminals receive laser beams pointed at the receivers. In turn, these receivers can identify the direction from which the laser beams were received and transmit return laser beams to establish the communications links.

In these depicted examples, a laser beam received at a receiver is directed towards a quad cell sensor by a mirror in the receiver. This mirror can rotate to change position to cause the laser beam to converge on a central location in the quad cell sensor. This change in position for convergence can be used to determine the location of the communications terminal transmitting the laser beam.

In these illustrative examples, a change in the position of the mirror causes a shift in the laser beam that changes the location of where the laser beam hits the quad cell sensor. The shift of the laser beam is an angular shift described with respect to an angular rotation of the mirror. Each time the laser beam is shifted, a detection occurs and that detection can be used to determine subsequent shifts to cause the laser beam to converge at the center on the quad cell sensor.

The different illustrative examples can provide a shift process that reduces the number of shifts needed to have the laser beam converge on the quad cell sensor in a manner that enables determining the location of the communications terminal from which the laser beam originated. In these illustrate examples, selection of how shifts are performed can be based on simulations of how different shifts converge on a quad cell sensor. In this example, the shift sequence can include at least one of a variable binary shift, a split variable shift, a variable shift using minimum average distance, and a hybrid of the split variable and variable shift using minimum distance.

In this example, a variable binary shift selects the first shift from all possible shifts in a simulation that results in the fastest convergence. With this example, subsequent shifts after the first shift are one half the distance of the prior shift.

The convergence occurs in a linear region. This linear region includes the center of the quad cell sensor. The linear region can also include an area that is some distance from the center of quad cell sensor that is considered sufficient for acquiring the location of the source of the laser beam.

Thus, convergence can occur when the laser beam is detected in the linear region, which can be the center of the center of the quad cell sensor or some distance from the center. In this example, the laser beam is in the linear region when the laser beam can be detected in all four quads of the quad cell sensor. This detection in a quad is present when a signal level sufficiently high to reliably indicate that the laser beam has been detected in that quad.

A split variable shift involves identifying a next shift in the sequence of shifts based upon the quad where the laser beam was detected and the current quad where the laser beam was detected after the prior shift. Each shift after a prior shift in the sequence of shifts is based on a starting quad from which the prior shift occurs and a current quad in which a detection occurs in response to the prior shift.

In this example, a split variable shift using a minimum average distance uses a sequence of shifts selected from a simulation of sequences of shifts that move an average distance of test points to converge on a linear region on a quad cell sensor. The sequence of shifts used from the simulation moves the average distance of the test points to converge on the linear region with a lowest number of shifts.

Further in this example, the hybrid shift selects shifts based on the quad in which a laser beam detected from a prior shift in which the shift is based on moving an average distance of the starting detection points.

The illustration of communications network 100 is meant to depict one example of hardware in which a list of examples can be implemented. This illustration is not meant to limit the manner in which other lists of examples can be implemented. For example, other communication systems can include additional ground vehicles in addition to car 109 and additional airplanes in addition to airplane 107 and airplane 106. Other illustrative examples can omit space station 104 or high altitude platform system 105. In another example, airplane 107 can also include a communications link with satellite 101 in addition to communications link 124 with airplane 106.

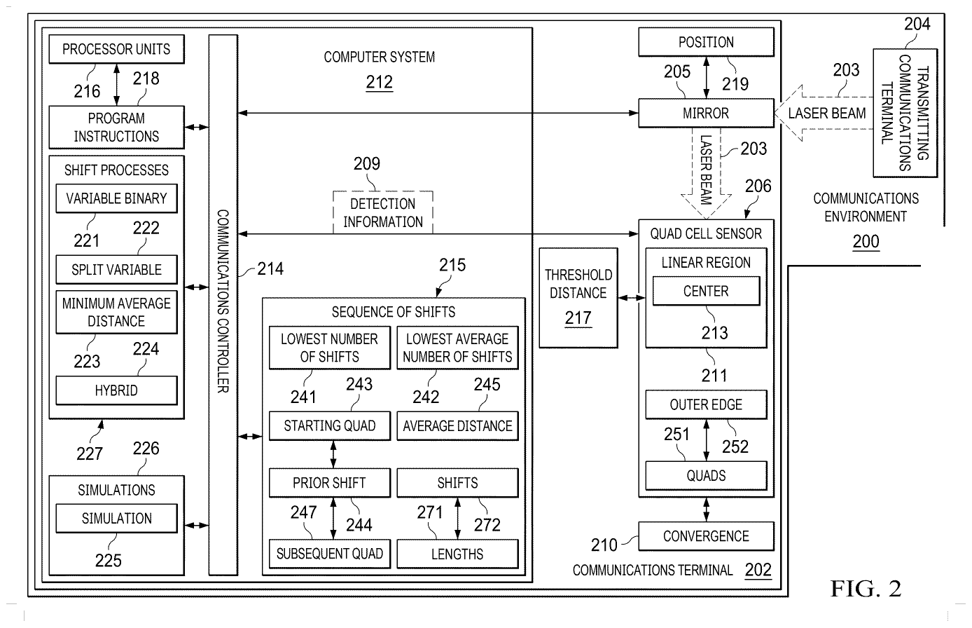

With reference now to FIG. 2, an illustration of a block diagram of a communications environment is depicted in accordance with an illustrative embodiment. In this illustrative example, communications environment 200 includes components that can be implemented in hardware such as the hardware shown in communications network 100 in FIG. 1.

In communications environment 200, communications terminal 202 can receive laser beam 203 from transmitting communications terminal 204. Communications terminal 202 and transmitting communications terminal 204 can take a number of different forms. For example, these communications terminals can be selected from at least one of a mobile platform, a stationary platform, a land-based structure, an aquatic-based structure, and a space-based structure. More specifically, the platform can be a surface ship, a tank, a personnel carrier, a train, a spacecraft, a space station, a satellite, a high altitude platform system (HAPS), a submarine, an automobile, a power plant, a bridge, a dam, a house, a manufacturing facility, a building, and other suitable platforms.

As depicted, laser beam 203 is received by mirror 205 in communications terminal 202. Mirror 205 reflects laser beam 203 to hit quad cell sensor 206 in communications terminal 202.

In this illustrative example, quad cell sensor 206 has four quadrants that are referred to as quads 251. Each of these represent one fourth of the area in quad cell sensor 206 and can be defined by equal angles of 90° at center 213 of quad cell sensor 206. Each quad in quads 251 is a portion of quad cell sensor 206 that detects the intensity of laser beam 203 within the area of that quad. Quad cell sensor 206 also detects a location where laser beam 203 hits quad cell sensor 206. This location can take a number of different forms. For example, the location can be an identification of the quad in which laser beam 203 is detected. The location can also include coordinates or other information identifying where in a quad in which laser beam 203 is detected.

In this example, the location where laser beam 203 hits quad cell sensor 206 forms detection information 209 and is sent to communications controller 214. In one illustrative example, the intensity can also be part of detection information 209.

This information is used as part of an acquisition process in which communications controller 214 determines the position of transmitting communications terminal 204 relative to communications terminal 202. This determination can include identifying the direction of laser beam 203 from transmitting communications terminal 204 to communications terminal 202 as laser beam 203 is received. Further, the determination can also include determining the location of transmitting communications terminal 204. These determinations are part of a process for establishing communications between communications terminal 202 and transmitting communications terminal 204.

Communications controller 214 can be implemented in software, hardware, firmware or a combination thereof. When software is used, the operations performed by communications controller 214 can be implemented in program instructions configured to run on hardware, such as a processor unit. When firmware is used, the operations performed by communications controller 214 can be implemented in program instructions and data and stored in persistent memory to run on a processor unit. When hardware is employed, the hardware can include circuits that operate to perform the operations in communications controller 214.

In the illustrative examples, the hardware can take a form selected from at least one of a circuit system, an integrated circuit, an application-specific integrated circuit (ASIC), a programmable logic device, or some other suitable type of hardware configured to perform a number of operations. With a programmable logic device, the device can be configured to perform the number of operations. The device can be reconfigured at a later time or can be permanently configured to perform the number of operations. Programmable logic devices include, for example, a programmable logic array, a programmable array logic, a field-programmable logic array, a field-programmable gate array, and other suitable hardware devices. Additionally, the processes can be implemented in organic components integrated with inorganic components and can be comprised entirely of organic components excluding a human being. For example, the processes can be implemented as circuits in organic semiconductors.

As used herein, “a number of” when used with reference to items, means one or more items. For example, “a number of operations” is one or more operations.

Further, the phrase “at least one of,” when used with a list of items, means different combinations of one or more of the listed items can be used, and only one of each item in the list may be needed. In other words, “at least one of” means any combination of items and number of items may be used from the list, but not all of the items in the list are required. The item can be a particular object, a thing, or a category.

For example, without limitation, “at least one of item A, item B, or item C” may include item A, item A and item B, or item B. This example also may include item A, item B, and item C or item B and item C. Of course, any combination of these items can be present. In some illustrative examples, “at least one of” can be, for example, without limitation, two of item A; one of item B; and ten of item C; four of item B and seven of item C; or other suitable combinations.

Computer system 212 is a physical hardware system and includes one or more data processing systems. When more than one data processing system is present in computer system 212, those data processing systems are in communication with each other using a communications medium. The communications medium can be a network. The data processing systems can be selected from at least one of a computer, a server computer, a tablet computer, or some other suitable data processing system.

As depicted, computer system 212 includes a number of processor units 216 that are capable of executing program instructions 218 and implementing processes in the illustrative examples. In other words, program instructions 218 are computer-readable program instructions.

As used herein, a processor unit in the number of processor units 216 is a hardware device and is comprised of hardware circuits such as those on an integrated circuit that respond to and process instructions and program code that operate a computer.

When the number of processor units 216 executes program instructions 218 for a process, the number of processor units 216 can be one or more processor units that are in the same computer or in different computers. In other words, the process can be distributed between processor units 216 on the same or different computers in computer system 212.

Further, the number of processor units 216 can be of the same type or different types of processor units. For example, the number of processor units 216 can be selected from at least one of a single core processor, a dual-core processor, a multi-processor core, a general-purpose central processing unit (CPU), a graphics processing unit (GPU), a digital signal processor (DSP), or some other type of processor unit.

In this illustrative example, communications controller 214 determines the location of transmitting communications terminal 204 transmitting laser beam 203 based on the detection information 209 obtained by performing shifts of laser beam 203. In this example, the shifts of laser beam 203 are performed by changing position 219 of mirror 205. For example, mirror 205 can be a fast steering mirror that rotates to shift where laser beam 203 is directed to on quad cell sensor 206.

In the illustrative example, mirror 205 can be rotated such that laser beam 203 hitting mirror 205 will move from one location on quad cell sensor 206 to another location on quad cell sensor 206.

In these illustrative examples, communications controller 214 controls mirror 205 and shifts mirror 205 to change where laser beam 203 hits quad cell sensor 206. In this example, the shifts are performed in a manner that reduces the time needed to determine the position of transmitting communications terminal 204.

In one illustrative example, communications terminal 202 shifts where laser beam 203 hits quad cell sensor 206 by changing the position of mirror 205. This shift is performed to reach convergence 210 on quad cell sensor 206. Convergence 210 is present when laser beam 203 is within linear region 211 in quad cell sensor 206.

In these examples, laser beam 203 is in linear region 211 when portions of laser beam 203 can be reliably detected in all four quads of quad cell sensor 206. For example, a detection of 15%, 15%, 35%, and 35% of the beam power in the four quads is in the linear region. With this detection, laser beam 203 can be quickly adjusted to be centered to center 213 on quad cell sensor 206.

In another example, a detection 1%, 1%, 49%, and 49% is made of the beam power. In this case laser beam 203 is not in linear region 211 because 1% of the beam power in a quad is not considered a reliable detection. For a detection to be considered reliable, the beam power in a quad is greater than a predefined threshold. This threshold can be selected to ensure the signal is distinguishable from noise and sensor inaccuracies.

In one example, linear region 211 is based on center 213 of quad cell sensor 206. In this example, linear region 211 can be a region on quad cell sensor 206 sufficiently close to center 213 of quad cell sensor 206 that enables determining the direction of laser beam 203 from transmitting communications terminal 204 with a desired level of accuracy for establishing communications with transmitting communications terminal 204.

For example, the selected distance can be zero such that convergence 210 is present when laser beam 203 is at center 213 of quad cell sensor 206. In other examples, convergence 210 is present when laser beam 203 is some other distance from center 213 that is considered to be in linear region 211. For example, convergence 210 can be within threshold distance 217 from center 213 for quad cell sensor 206.

Threshold distance 217 can be selected in a number of different ways. For example, the threshold distance 217 may be based on a sequence that has a lower number of shifts versus 100% convergence. Threshold distance 217 can also be selected as the distance from center 213 where laser beam 203 can be measured in all four quads of quad cell sensor 206. In one example, the quad has the same power threshold. If this threshold is met in all four quads then laser beam 203 is in linear region 211.

It is desirable to reach convergence 210 as quickly as possible in reducing the time needed to establish communication with transmitting communications terminal 204. A time needed to reach convergence 210 can be reduced by reducing the number of shifts performed for laser beam 203.

In one illustrative example, convergence 210 occurs by shifting laser beam 203 using sequence of shifts 215. In one illustrative example, sequence of shifts 215 is five shifts. The number of shifts for sequence of shifts 215 can be dependent on the ratio of the diameter of quad cell sensor 206 to the diameter of linear region 211.

Shifts 272 in sequence of shifts 215 are angular shifts or angular displacements of laser beam 203. In these examples, shifts 272 in sequence of shifts 215 have lengths 271 that are angular. An angular shift is caused by changing position 219 of mirror 205 through the rotation of mirror 205 that causes an angular change in direction of laser beam 203 traveling from mirror 205 to quad cell sensor 206. This angular displacement of laser beam 203 on quad cell sensor 206 can be used to determine a linear displacement in terms of the change in location of laser beam 203 on quad cell sensor 206.

In the depicted example, communications terminal 202 can be a platform in which quad cell sensor 206, mirror 205, computer system 212, and communications controller 214 are located. For example, the platform can be selected from a group comprising a mobile platform, a stationary platform, a land-based structure, an aquatic-based structure, a space-based structure, a surface ship, a tank, a personnel carrier, a train, a spacecraft, a space station, a satellite, a high altitude platform system, a submarine, an automobile, a power plant, a bridge, a dam, a house, a manufacturing facility, a building, or some other suitable platform.

In these examples, the shifting of laser beam 203 is performed by changing the position of mirror 205. This shifting can be performed using one or more different types of shift processes 227. Shift processes 227 include, for example, variable binary 221, split variable 222, minimum average distance 223, and hybrid 224. Each of these shift processes uses sequences of shifts to reach convergence 210. In these examples, the particular shift sequence employed by each shift process is based on the results of a particular simulation in simulations 226.

In this illustrative example, with variable binary 221, communications controller 214 identifies sequence of shifts 215 having a first shift from first shifts in simulation 225 of sequences of shifts performed for test points to reach convergence on quad cell sensor 206 in which the first shift has at least one of lowest number of shifts 241 or lowest average number of shifts 242 for laser beam 203 to reach convergence 210 for test points in simulation 225. **NP Each shift after the first shift is one half of a prior shift in sequence of shifts 215. Each shift is in a direction away from an outer edge 252 for a quad in quads 251 in quad cell sensor 206 in which laser beam 203 is detected.

The average number of shifts represents the mean number of shifts required for all test points to converge on a test quad cell sensor in simulation 225. The test quad cell sensor represents quad cell sensor 206 in simulation 225.

This average convergence is calculated by summing the total number of shifts for all test points and dividing by the number of test points. A lower average number of shifts indicates that more test points converged earlier in the process, requiring fewer shifts overall. This reflects higher efficiency in achieving convergence, as a smaller portion of the test points needed additional shifts. On the other hand, a higher average number of shifts means that the test points require more shifts to move towards convergence. This can indicate a less efficient convergence process.

In a first example, a first shift of five test points results in one test point converging at the center of the test quad cell sensor resulting in a 20% convergence of the test points. A second shift does not result in any additional test points converging. In this case, the convergence of test points is still 20%. In response to a third shift, the remaining four test points converged for 100% convergence of the test points.

In this case, the average number of shifts is 1+3+3+3+3=13. The average number of shifts is total shifts/number of test points. In this case, the average number of shifts is 2.6.

In a second example, a first shift of five test points results in four test points converging at a center of the test quad cell sensor resulting in an 80% convergence of the test points. A second shift does not result in any additional test points converging. The convergence of test points remains at 80%. A third shift of the remaining test points results in convergence of that test point for 100% convergence of the test points.

The total number of shifts needed to shift the test points to convergence is 7. In this example, the average number of shifts is 1.4. As a result, this second example results in the test points converging more quickly as compared to the first example, and has a higher number of shifts.

In this example, communications controller 214 changes position 219 of mirror 205 receiving laser beam 203 using the first shift in sequence of shifts 215. Further, communications controller 214 changes the position of mirror 205 such that each shift after the first shift in sequence of shifts 215 is one half of the prior shift.

In another illustrative example, communications controller 214 uses split variable 222 in shift processes 227 to shift laser beam 203 on quad cell sensor 206. With this shift process, communications controller 214 identifies sequence of shifts 215 from simulation 225 of shifts for test points to reach convergence 210 on quad cell sensor 206 in which sequence of shifts 215 has a lowest number of shifts 241 and a lowest average number of shifts 242 to reach convergence 210 for the test points in simulations 226. With this shift process, each shift after prior shift 244 in sequence of shifts 215 is based on starting quad 243 from which prior shift 244 occurs in subsequent quad 247 in which a detection occurs in response to prior shift 244. Subsequent quad 247 is the quad in which laser beam 203 is detected after the prior shift. This information is used to select the shift from sequence of shifts 215.

Communications controller 214 changes position 219 of mirror 205 receiving laser beam 203 using sequence of shifts 215. This shifting of laser beam 203 using sequence of shifts 215 causes laser beam 203 to converge on linear region 211 of quad cell sensor 206. This convergence may cause laser beam 203 to reach linear region 211.

In another illustrative example, communications controller 214 uses minimum average distance 223 in shift processes 227 to perform shifts of laser beam 203 on quad cell sensor 206. For example, communications controller 214 identifies sequence of shifts 215 from simulation 225 of sequences of shifts that move average distance 245 of test points to reach convergence 210 on quad cell sensor 206. With this shift process, sequence of shifts 215 moves average distance 245 of the test points to converge on linear region 211 with lowest number of shifts 241. Communications controller 214 changes position 219 of mirror 205 receiving laser beam 203 using sequence of shifts 215.

In another example, hybrid 224 is a hybrid of split variable 222 and minimum average distance 223. When using this shift process, communications controller 214 identifies sequence of shifts 215 from simulation 225 of sequences of shifts.

In these illustrative examples, shifts 272 in sequence of shifts 215 have lengths 271 with values that are based on the selection of a particular sequence of shifts in sequences of shifts simulated using simulations 226. Each of these simulations can simulate shifts based on the type of shifting performed using shift processes 227. The result of simulations 226 are sequences of shifts in which each sequence of shifts can have shifts with different shift lengths. In this example, sequence of shifts 215 can be selected as one having at least one of lowest number of shifts 241 or lowest average number of shifts 242 to reach convergence 210.

In this example, convergence 210 can be present when 100% of the test points converge (weighted, of course). In other examples, convergence 210 can be considered present when 90% of the test points converge on center 213. If two simulations have the same lowest number of lowest shifts, simulation with the lowest average number of shifts is used to select the sequence of shifts 215.

In one illustrative example, one or more technical solutions are present that overcome a technical problem with reducing the number of shifts needed to locate a communications terminal transmitting a laser beam. The reducing in the number of shifts can be performed in a manner that that reduces the time needed to reach convergence on a quad cell sensors. One or more shifting processes described in these illustrative examples can increase the speed in establishing communications by reducing the number of shifts needed to locate a communications terminal transmitting a laser beam.

Computer system 212 can be configured to perform at least one of the steps, operations, or actions described in the different illustrative examples using software, hardware, firmware or a combination thereof. As a result, computer system 212 operates as a special purpose computer system in which communications controller 214 in computer system 212 enables shifting a laser beam received from a communications terminal. In particular, communications controller 214 transforms computer system 212 into a special purpose computer system as compared to currently available general computer systems that do not have communications controller 214.

The illustration of communications environment 200 in FIG. 2 is not meant to imply physical or architectural limitations to the manner in which an illustrative embodiment may be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment.

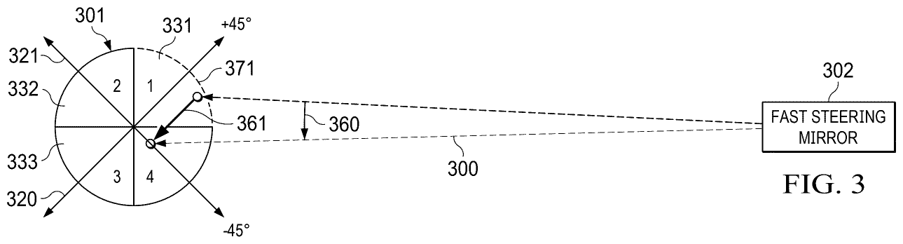

Turning to FIG. 3, an illustration of shifting of the laser beam is depicted in accordance with an illustrative embodiment. In this example, laser beam 300 is directed towards quad cell sensor 301 by fast steering mirror 302. Laser beam 300 is an example of laser beam 203 in FIG. 2. Fast steering mirror 302 is an example of an implementation for mirror 205 in FIG. 2. Quad cell sensor 301 is an example of an implementation for quad cell sensor 206 in FIG. 2.

As depicted, quad cell sensor 206 has four quads: quad 1 331, quad 2 332, quad 3 333, and quad 4 334.

In this illustrative example, fast steering mirror 302 is rotatable to shift the reflection of laser beams along +45°axis 320 and −45°axis 321. Depending on the implementation, laser beam 300 can be shifted along other axes or directions.

As depicted, fast steering mirror 302 performs shift 360 of the laser beam from being detected in quad 1 331 to quad 4 334 by rotating fast steering mirror 302 about +45 degree axis 320.

In this example, shift 360 is an angular shift having a length that is measured in microradians. The length of the shift is expressed as an angle. This angle is measured relative to an axis through the central axis of the laser beam 300.

This angular shift can be used to determine the linear movement along arrow 361 on quad cell sensor 301. In these examples, shift 360 of laser beam 300 is away from the outer edge of a quad. The outer edge of a quad is an edge that is not adjacent to another quad. For example, quad 1 has outer edge 371.

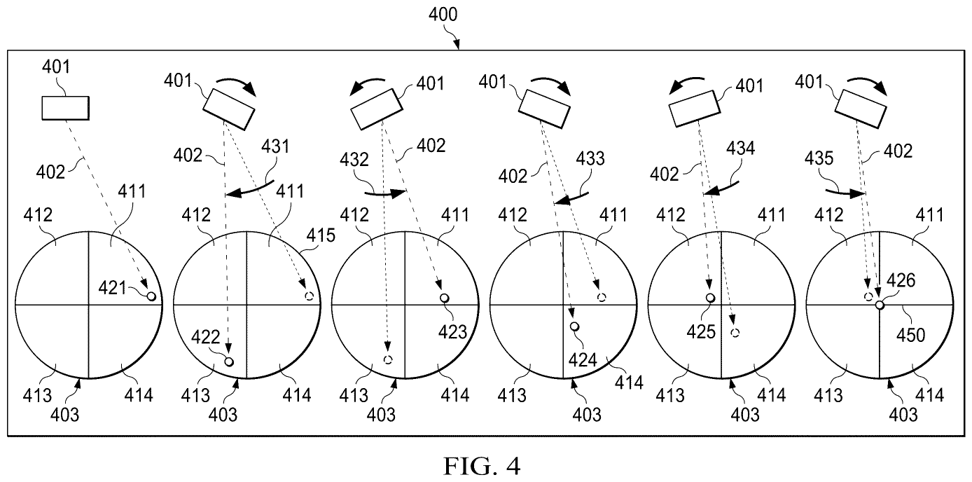

Turning now to FIG. 4, an illustration of a shift sequence is depicted in accordance with an illustrative embodiment. In this illustrative example, shift sequence 400 is an example of a shift sequence that can be performed using one or more of shift processes 227.

As depicted, mirror 401 reflects laser beam 402 at quad cell sensor 403. In this illustrative example, mirror 401 is an example of mirror 205 in FIG. 2, laser beam 402 is an example of laser beam 203 in FIG. 2, and quad cell sensor 403 is an example of quad cell sensor 206 in FIG. 2. In this example, quad cell sensor 403 includes quad 1 411, quad 2 412, quad 3 413, and quad 4 414. Mirror 401 can rotate to shift where laser beam 402 hits the surface of quad cell sensor 403.

In this example, detection 1 421 of laser beam 402 is in quad 1 411. In this example, shift 1 431 of laser beam 402 is in a direction away from edge 415 of quad 1 411. Each shift of laser beam 402 is away from the outer edge of a quad in these examples. The shifts of laser beam 402 are angular shifts, which are measured in radians. The angular displacement is measured relative to an axis extending through laser beam 402.

The next detection in response to shift 1 431 is detection 2 422 of laser beam 402 in quad 3 413. In response to this detection, shift 2 432 is performed. As depicted, shift 2 432 results in detection 2 423 of the laser beam in quad 1 411. Next, shift 3 433 is performed resulting in detection 4 424 of laser beam 402 in quad 4 414.

Next, shift 4 434 is performed causing the laser beam to be detected in detection 5 425 in quad 2 412. In response to this detection, shift 5 435 is performed, resulting in detection 6 426 of laser beam 203 in linear region 450, which is the center of quad cell sensor 403 in this example. When laser beam 203 is in linear region 450, an equal detection of laser beam 402 can occur in quad 1 411, quad 2 412, quad 3 413, and quad 4 414. This equal detection indicates that laser beam 402 is at the center of quad cell sensor 403. In this example, the convergence from the shifting of laser beam 402 using shift sequence 400 is a 100% convergence at the center of quad cell sensor 403 in linear region 450.

In this example, five shifts are performed, and six detections occur in performing shift sequence 400. Further, in this illustrative example, the length of each shift is dependent on the particular shift process used. For example, if the shift process is a variable binary, each shift after the first shift in the sequence of shifts is one half the distance of a prior shift. This sequence of shifts from the simulation has a lowest number of shifts and a lowest average number of shifts to reach the convergence for the test points in the simulation.

In another example, with a split variable for the shift process, the length of each shift in the sequence of shifts is dependent on the quad in which the shift began in the quad in which the shift ends. In other words, each shift after a prior shift in the sequence of shifts for a shift process using the split variable is based on a starting quad from which the prior shift occurs and a subsequent quad in which a detection occurs in response to the prior shift. The sequence of shifts for this shift process is a sequence of shifts in the simulation that has a lowest number of shifts and a lowest average number of shifts to reach the convergence for the test points in the simulation.

In yet another example, a shift process using an average distance employs a sequence of shifts with shift lengths that move a minimum average distance and employs shift lengths based on a shift identified from a simulation that moves an average distance of test points to reach a convergence on a quad cell sensor. This sequence is one from the simulation that moves the average distance of the test points to converge on the linear region with a lowest number of shifts.

In yet another example, a shift process that is a hybrid uses both split variable and minimum average distance. With this type of shifting, the length of the shifts are selected from a sequence of shifts from a simulation in which each shift after a prior shift in the sequence of shifts is based on a quad in which an average distance of the test points from a prior quad that are detected in a current quad in response to the prior shift of the test points in the prior quad and in which the average distance of the test points in the current quad move towards a linear region. The sequence of shifts selected from the simulation is one that has at least one of a lowest number of shifts or a lowest number of shifts for the average distance of the test points to reach a convergence.

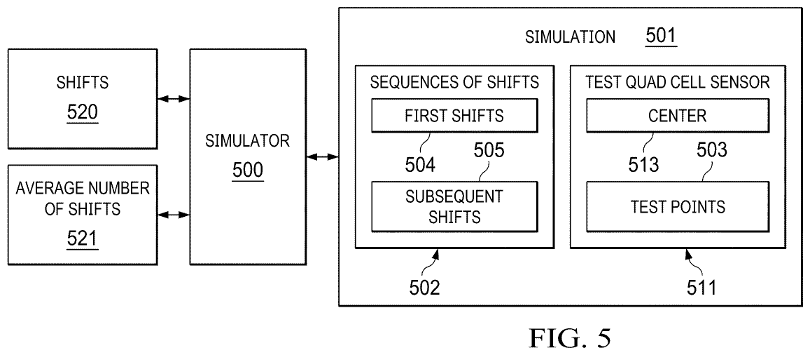

Turning now to FIG. 5, an illustration of a simulation of shifts for a laser beam is depicted in accordance with an illustrative embodiment. In this example, simulator 500 performs simulation 501. Simulator 500 can be implemented in at least one of hardware or software.

Simulation 501 is an example of a simulation in simulations 226 in FIG. 2. In this example, simulation 501 is performed to identify a sequence of shifts used in a shift process such as variable binary 221 in FIG. 2.

In this example, simulator 500 simulates sequences of shifts 502 for test points 503 on test quad cell sensor 511 in simulation 501. A test point is a location on test quad cell sensor 511 where a laser beam is detected.

Each test point in test points 503 undergoes shifts for a sequence of shifts. The shifting of the test point from one location to another occurs when the laser beam is shifted such that the detection of the test point moves from one location to another location test quad cell sensor 511. Sequences of shifts 502 are shifts of the laser beam needed to reach convergence on center 513 on test quad cell sensor 511.

In this example, each of these shifts is an angular shift and each one has a different length. The convergence can be a 100% convergence or some lower level convergence. For example, convergence may also be 95%, 80%, or some other level of convergence.

As depicted in this example, sequences of shifts 502 have first shifts 504 and subsequent shifts 505. For example, each sequence and sequences of shifts 502 has a first shift in first shifts 504 and a number of shifts in subsequent shifts 505. Each shift is performed in a direction away from the outer edge of test quad cell sensor 511.

Sequences of shifts 502 can have different numbers of shifts. For example, one sequence of shifts may have a first shift and four subsequent shifts while another sequence of shifts has a first shift and three subsequent shifts.

Thus, in simulation 501, each test point in test points 503 undergoes a sequence of shifts in sequences of shifts 502. Further, simulation 501 uses multiple first shifts in which each first shift has a different length from another first shift in first shifts 504. For each first shift, the sequence of subsequent shifts is applied. In this example, each shift after the first shift in a sequence of shifts is one half of the prior shift in the sequence of shifts. Thus, this first shift with a selected length is performed for each test point in test points 503. Then, another first shift with another length is performed for test points 503.

Thus, simulation 501 performs first shifts on each of test points 503 with subsequent shifts in which each first shift in first shifts 503 has a different length. In this manner, simulation 501 can iterate through different combinations of first shifts from different detection points.

Simulator 500 collects data for the detection of test points 503 for each of the shifts and sequences of shifts 502 performed for test points 503. For example, simulator 500 records the location of each test point from the first detection to the final detection at convergence from performing sequences of shifts 502. These detections of the test points are associated with the shifts in sequences of shifts 502. Thus, simulation 501 iterates through all combinations of first shifts in the sequences of shifts and subsequent shifts providing data for analysis by simulator 500.

With this data, simulator 500 determines a number of shifts 520 to reach convergence from each of the first shifts in the sequences. Simulator 500 also determines average number of shifts 521 to reach the convergence from each of the first shifts in the sequences. With this information, sequence of shifts 215 can be selected from sequences of shifts 502 for use in variable binary 221 to shift laser beam 203 in FIG. 2.

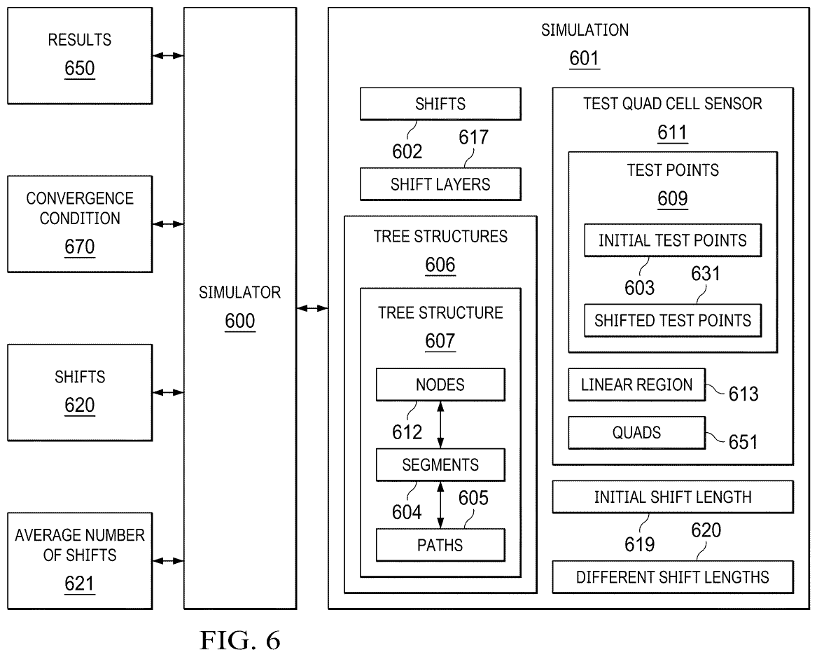

Next in FIG. 6, an illustration of a simulation of shifts for a laser beam is depicted in accordance with an illustrative embodiment. In this illustrative example, simulator 600 performs simulation 601. Simulator 600 can be implemented in at least one of hardware or software. Simulation 601 is a process run and controlled by simulator 600.

Simulation 601 is an example of a simulation in simulations 226 in FIG. 2. In this example, simulation 601 is performed to identify a sequence of shifts used in a shift process such as split variable 222 in FIG. 2. In these examples, simulation 601 generates tree structures 606 from which one of these tree structures can be selected for use in identifying sequence of shifts 215 for shifting laser beam 203 to reach convergence on quad cell sensor 206 in FIG. 2.

In this example, simulator 600 simulates shifts 602 for test points 609 on test quad cell sensor 611 in simulation 601. During simulation 601, information for changes to paths 605 occurring in response to shifts 602 is recorded as results 650. These paths branch from detections of test points 609 as these test points are shifted to form tree structure 607 in tree structures 606. In this example, tree structure 607 is comprised of nodes 612 and segments 604.

A node in nodes 612 represents a quad. This node includes a node identifier and an identification of a quad in quads 651.

In other words, for purposes of simulation 601, the node can identify test points 609 that are detected in each of quads 651. A node can also include an identification of the location of test points within each quad. This identification can be informed of coordinates such as angular coordinates. This information is unnecessary in using tree structure 607 to identify sequence of shifts 215 to perform shifts 272 to shift laser beam 203 in FIG. 2.

A segment in segments 604 comprises a segment identifier and a shift length for a shift. The segment also identifies two nodes in nodes 612 connected by the segment. In this example, the two nodes are a prior node for a prior quad and a subsequent node for a subsequent quad. These nodes and segments define paths 605 through tree structure 607.

Shifts 602 performed on test points 609 are used to form segments 604 in tree structure 607 that define paths 605 in tree structure 607. Segments 604 connecting nodes 612 with each other define paths 605 in tree structure 607. The starting quad before a shift and the subsequent quad after a shift are used to generate a pair of nodes connected by the segment.

In this example, a test point in test points 609 is a location on test quad cell sensor 611 where a laser beam is detected. The shifting of a test point from one location to another occurs when the laser beam is shifted by rotating a mirror reflecting the laser beam onto test quad cell sensor 611 such that the detection of the laser beam moves from one location to another location in test quad cell sensor 611. In this example, the shifting of test points 609 is in a direction away from the outer edge of a quad in test quad cell sensor 611 where test points 609 are detected.

In this illustrative example, a first detection D1 of initial test points 603 is performed before shifting of these initial test points. This detection identifies the quad in test quad cell sensor 611 in which initial test points 603 are located for simulation 601.

In this example, all of initial test points 603 are located in the same starting quad, quad Q1, for purposes of simplifying the explanation. In other illustrative examples, initial test points 603 can be distributed between one or more of quads 651 in test quad cell sensor 611.

Simulation 601 performs shifts 602 using shift layers 617. A shift layer comprises the shifts lengths selected for shifts performed between two consecutive detections.

In this example, a shift of the initial test points 603 can be performed using initial shift length 619 for initial shift layer S1 in shift layers 617. In this first shift the same shift length is used for all of initial test points 603.

After shifting of initial test points 603 by initial shift length 619 from the starting quad, shifted test points 631 are detected in a second detection D2. In the second detection D2, shifted test points 631 can be in one or more of quads 651 in test quad cell sensor 611.

In this example, in the second detection D2, shifted test points 631 are in all four quads. The subsequent quad after shifts 602 in the initial shift layer S1 can be one of quad Q1, quad Q2, quad Q3, and quad Q4.

In subsequent shifts layers, after the initial shift layer S1, different shift lengths 620 are used instead of initial shift length 619. In this example, each shift length in different shift lengths 620 is different from other shift lengths in different shift lengths 620.

In these examples, a first shift length in different shift lengths 620 is used for quad Q1, which is the same quad as the starting quad. A second shift length in different shift lengths 620 is used for quad Q3, which is an opposite quad to quad Q1. A third shift length in different shift lengths 620 is used for both quad Q2 and quad Q4, which are adjacent quads to quad Q1 in this example.

Shifts 602 within a shift layer in shift layers 617 can have different shift lengths. Each shift layer can have different combinations of different shift lengths 620 from other shift layers in shift layers 617.

The particular shift lengths used for shifts 602 in shift layers 617 can be randomly selected from different shift lengths 620. In other examples, the particular shift lengths can be selected from different shift lengths 620 based on some predetermined order. If not all of different shift lengths 620 are used in all desired permutations, other combinations of shift lengths can be selected in simulation 601 to create other tree structures in tree structures 606 in addition to tree structure 607.

In this manner, different tree structures have some or all of the different combinations of different shift lengths 620. Thus, different permutations of different shift lengths 620 can be used in the simulation of shifts 602 to generate tree structures 606 in which different tree structures can have different statistics with respect to at least one of the number of shifts 602 to reach convergence or average number of shifts 621 to reach convergence.

In this example, shifted test points 631 are grouped for shifting in these shift layers. The grouping is based on quads 651 in which shifted test points 631 are detected. For example, shifted test points 631 detected in quad Q3 are all grouped into one group. Similar groupings are made based on shifted test points 631 detected in other quads.

With this example, each group of shifted test points 631 is shifted by a shift length selected for that quad. Thus, groups of shifted test points 631 are shifted by different lengths in different shift lengths 620.

For example, in the second shift layer S2 in shift layers 617, shifts 602 are performed for the groups of shifted test points 631 based on quads 651 in which the shift points were detected in detection D2. The shifting is based on quads 651 in which a test point is detected.

In this example, in the second detection D2, a group of shifted test points 631 is present in each of the four quads. With this detection of the groups of shifted test points 631 in the second detection D2, each group of shifted test points 631 are shifted by these three shift lengths based on the quad in which a group of shifted test points 631 is detected.

For example, a first shift length in different shift lengths 620 is used for the group of shifted test points 631 in quad Q1; a second shift length in different shift lengths 620 is used for the group of shifted test points 631 in quad Q3. A third shift length in different shift lengths 620 is used for the group of shifted test points 631 in both quad Q2 and quad Q4.

These two quads are treated the same using the same shift length because both of the quads are adjacent to quad Q1. Shifts 602 performed on the groups of shifted test points 631 in the second shift layer S2 results in three segments in segments 604 that branch from the node for detection D2 in tree structure 607.

As a result, shifts 602 in the second shift layer S2 result in shifted test points 631 being detected in a third detection D3. These shifted test points are grouped into groups of shifted test points 631 based on the quads in which shifted test points 631 detected in the third detection D3.

Shifting performed in the second shift layer may result in some shifted test points moving from one group to another group. For example, two shifted test points, a first shifted test point and a second shifted test point, are detected in the second detection D2 in quad Q3 in response to being shifted in the first shift layer S1.

Shifting these two shifted points by the same shift length in the second shift layer S2 results in the first shifted test point being detected in quad Q3 and the second shifted test point being detected in quad Q1. Although these two shifted test points were in the same group, they are now grouped into two different groups because the two shifted test points have been detected in different quads during the second detection D2.

In this illustrative example, simulator 600 records shifts 602 with associated shift lengths and quads 651 in which shifted test points 631 are detected as part of results 650. Further, the starting quad detected prior to a shift and the subsequent quad detected after a shift are identified for each portion of a path in paths 605 in results 650.

Each segment in segments 604 represents a shift for a group of test points 609. The shift length of the shift is identified in results 650 along with the starting quad from which the shift occurred and the subsequent quad in which a detection occurs in response to the shift by the shift length.

This detecting of quads for shifted test points 631, grouping of shifted test points 631, and shifting the groups of shifted test points 631 can be repeated for any number of shift layers until convergence condition 670 is met.

In this example, convergence condition 670 can be met in a number of different ways. For example, this condition can be met when shifted test points 631 reach linear region 613. In another example, convergence condition 670 can be a set number of shifts in which convergence to linear region 613 is expected. For example, if convergence normally occurs within five shifts, the number of shifts can be five. In another example, additional shifts can be used in addition to the expected number of shifts for convergence condition 670.

In this illustrative example, if a shifted test point reaches convergence for a path in shifts 602 before convergence condition 670 is reached for all of shifted test points 631, additional shifting from that shifted test point is unnecessary. For example, if shifting of the shifted test point along one path in paths 605 reaches convergence in three shifts, the last two shifts do not need to be performed for that shifted test point.

With results 650, simulator 600 determines a number of shifts 602 to reach the convergence for each path in paths 605. Simulator 600 also determines average number of shifts 621 to reach the convergence for each of the sequences of the shifts 602.

Simulator 600 can control simulation 601 to perform this detecting, grouping, and shifting to simulate shifts for any desired number of different shift lengths 620. These different permutations can be covered by repeating the process to create additional tree structures in tree structures 606. These different tree structures can then be evaluated to determine the tree structure having at least one of the lowest number of shifts 602 to reach convergence or the lowest average number of shifts 621 to reach convergence. This tree structure is then used as the tree structure to identify sequence of shifts 215 for shifting laser beam 203 in FIG. 2.

Thus, sequence of shifts 215 can be performed using the paths through the identified tree structure based on the quads in which detections are made. With this tree structure, the shifts performed in the sequence of shifts depends on the starting quad in which a detection occurred before a shift and the subsequent quad in which a detection occurs after the shift is performed.

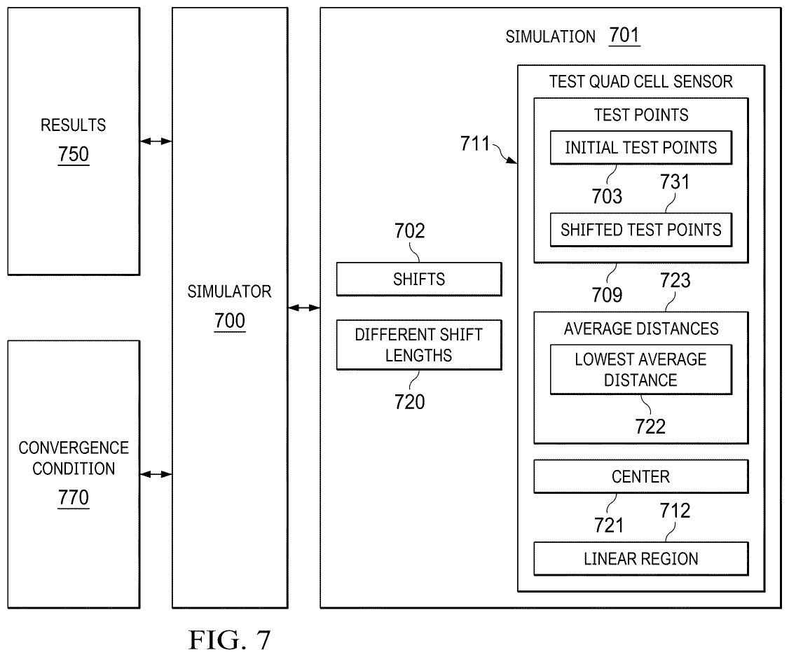

With reference to FIG. 7, an illustration of a simulation of shifts for a laser beam is depicted in accordance with an illustrative embodiment. In this illustrative example, simulator 700 performs simulation 701. Simulator 700 can be implemented in at least one of hardware or software.

Simulation 701 is an example of a simulation in simulations 226 in FIG. 2. In this example, simulation 701 is performed to identify a sequence of shifts used in a shift process such as minimum average distance 223 in FIG. 2. The results of simulation 701 are used to select sequence of shifts 215 for use in split variable 222 in FIG. 2. In this example, a test point is a location on test quad cell sensor 711 where a laser beam is detected.

In this example, simulator 700 simulates shifts 702 for test points 709 on test quad cell sensor 711 in simulation 701. The shifting of test points 709 from one location to another occurs when the laser beam is shifted by rotating a mirror reflecting the laser beam onto test quad cell sensor 711 such that the detection of the laser beam moves from one location to another location on test quad cell sensor 711. In this example, each shift of a test point is in a direction away from the outer edge of a quad in test quad cell sensor 711 where a test point is detected.

In this illustrative example, initial test points 703 are selected on test quad cell sensor 711. These initial test points are shifted by different shift lengths 720 to form groups of shifted test points 731. Each group corresponds to shifted test points 731 shifted by one of different shift lengths 720.

For example, if five initial test points are present and two different shift lengths are present, the five initial test points were shifted by the first shift length as a first group of initial test points. Those initial test points are also shifted by the second shift length to form a second group of initial test points.

Thus, a group of shifted test points 731 is formed each time initial test points 703 are shifted by one of different shift lengths 720. As a result of shifting, the number of shifted test points 731 increases based on the number of different shift lengths 720 used. The number of different shift lengths 720 correspond to the number of groups that shifted test points 731 that are formed from shifting test points 709.

In simulation 701, average distances 723 to center 721 are determined for the groups of shifted test points 731. For example, a distance of each shifted test point to center 721 is determined. The distances to center 721 for shifted test points 731 in a group of shifted test points 731 are averaged. This determination is performed for each group of shifted test points 731.

Simulation 701 finds a selected group of shifted test points 731 having lowest average distance 722 and average distances 723 to center 721 of test quad cell sensor 711. The other groups of shifted test points 731 that are not selected can be discarded in simulation 701.

This selected group of shifted test points 731 is retained and shifted using different shift lengths 720. This shifting of the selected group of shifted test points 731 forms groups of shifted test points 731. A group of shifted test points is formed from each shift using a different shift length in different shift lengths 720.

In this example, average distances 723 to center 721 of test quad cell sensor 711 are determined for the groups of shifted test points 731. Further, shifted test points 731 can be weighted based on their location on test quad cell sensor 711. For example, test points closer to center 721 can have a weight of 0.9 while a test point closer to the outer edge of a quad can have a weight of 0.1. These weights can then be used in determining average distances 723 for the different groups of shifted test points 731.

In simulation 701, identifying the selected group, shifting the selected group, and determining average distances 723 are performed until lowest average distance 722 of the selected group of shifted test points 731 reaches a convergence condition 770. In this depicted example, convergence condition 770 can occur in a number of different ways. For example, this convergence condition can be met when the average distance of a group of shifted test points 731 reaches linear region 712.

In another example, convergence condition 770 can be present when the average distance is not 100% convergence. For example, the average distance can be considered to meet convergence condition 770 when convergence is 85%, 90%, or some other percentage of convergence for the average distance to center 721.

In yet another example, convergence condition 770 can be the number of shifts performed in which the number of shifts is selected based on when convergence is expected for test points 709. For example, if convergence normally occurs within five shifts, the number of shifts can be five. In another example, additional shifts can be used in addition to the expected number of shifts for convergence condition 770.

In this example, results 750 from performing shifts 702 are recorded. The shift lengths and the resulting average distances of shifts 702 performed on shifted test points 731 can be recorded. Results 750 include the shift length used in shifts 702 that had lowest average distance 722.

As a result, results 750 are obtained for each iteration of shifts 702 of shifted test points 731 that identify the shift length that resulted in lowest average distance 722 in an iteration. When simulation 701 completes, sequence of shifts 215 can be identified from the shift lengths used for shifts 702 that resulted in lowest average distances or shifted test points 731 in results 750.

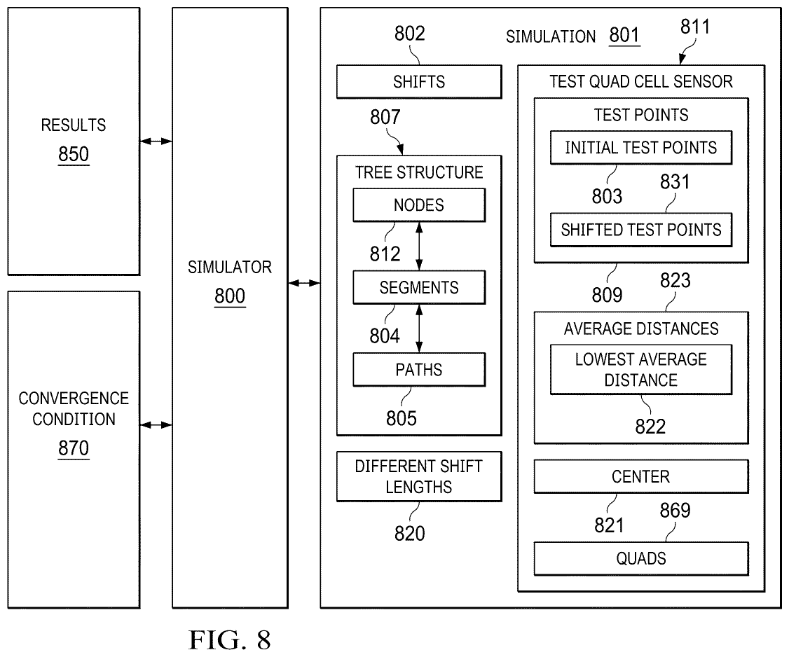

Turning now to FIG. 8, an illustration of a simulation of shifts for a laser beam is depicted in accordance with an illustrative embodiment. In this illustrative example, simulator 800 performs simulation 801. Simulator 800 can be implemented in at least one of hardware or software. Simulation 801 is a process run and controlled by simulator 800.

In this example, simulation 801 is an example of a simulation in simulations 226 in FIG. 2. In this example, simulation 801 is performed to identify a sequence of shifts used in a shift process such as hybrid 224 in FIG. 2. In these examples, simulation 801 generates tree structure 807 from shifting test points 709 on test quad cell sensor 811. In this example, tree structure 807 has nodes 812 and segments 804 that connect nodes 812 to each other.

A node in nodes 812 represents a quad. This node includes a node identifier and an identification of a quad in quads 851.

In other words, for purposes of simulation 801, the node can identify test points 809 that are detected in each of quads 869 in test quad cell sensor 811. A node can also include an identification of the location of test points within each quad. This identification can be in the form of coordinates such as angular coordinates. This information is unnecessary in using tree structure 807 to identify sequence of shifts 215 to perform shifts 272 to shift laser beam 203 in FIG. 2.

A segment in segments 804 comprises a segment identifier and a shift length for a shift. The segment also identifies two nodes in nodes 812 connected by the segment. In this example, the two nodes is a prior node for a prior quad, and a subsequent node for a subsequent quad.

A segment in segments 804 comprises a segment identifier and a shift length for a shift. The segment also identifies two nodes in nodes 812 connected by the segment. In this example, the two nodes is a prior node for a prior quad and a subsequent node for a subsequent quad. These nodes and segments define paths 805 through tree structure 807.

Segments 804 connecting nodes 812 with each other define paths 805 in tree structure 807. The starting quad before a shift and the subsequent quad after the shift are used to generate a pair of nodes connected by the segment.

The final form of tree structure 807 can be selected for use in identifying sequence of shifts 215 for shifting laser beam 203 to reach convergence on quad cell sensor 206 in FIG. 2.

In this example, simulator 800 simulates shifts 802 for test points 809 on test quad cell sensor 811 in simulation 801. In simulation 801, initial test points 803 in test points 809 are selected. In this example, initial test points 803 are all in the same quad, which is quad Q1. Initial test points 803 are shifted by different shift lengths 820. In this example, all of initial test points 803 are shifted by each of different shift lengths 820 to form groups of shifted test points 831.

For example, initial test points 803 comprises ten test points and different shift lengths 820 are three shift lengths such as B1, B2, and B3. The ten test points are shifted by the first shift length B1, the second shift length B2, and third shift length B3. This shifting results in detection of three groups of ten test points to form the groups of shifted test points 831.

Simulation 801 calculates average distances 823 for the three groups of shifted test points 831. An average distance is an average distance to center 821 of test quad cell sensor 811. A selected group of shifted test points 831 having lowest average distance 722 to center 821 of test quad cell sensor 811 is identified for further processing.

In this example, simulation 801 groups shifted test points 831 from a selected group of shifted test points into groups of shifted test points 831 for further shifting. The selection of the groups from the selected group of shifted test points 831 is based on the quads where these shifted test points are located.

For example, a selected group of shifted test points 831 are detected in three quads such as two test points in quad Q1, five test points in quad Q2, and three test points in quad Q3. Thus, the shifted test points 831 in the selected group is grouped to form two or three of shifted test points 831 in which a first group G1 has two shifted test points, a second group G2 has five shifted test points, and a third group G3 has three shifted test points.

A shift in these three groups of shifted test points 831 is performed using different shift lengths 820. For example, the two shifted test points in group G1 are shifted by shift lengths L1, L2, and L3. In a similar fashion, the five shifted test points in group G2 are shifted by shift lengths L1, L2, and L3, and the three shifted test points in group G3 are shifted by shift lengths L1, L2, and L3.

This shifting forms new groups of shifted test points 831. The use of three different shift lengths to shift shifted test points 831 in each of the three groups results in new groups of shifted test points 831. In this case, each group of shifted test points results in three groups of shifted test points, one group being formed from each of the three shift points used in this example.

With this example, the three groups formed from group G1 are groups G1a, G1b, and G1c which are groups from shifting shifted test points 831 in group G1 by shift length L1, L2, and L3, respectively. These three groups form a first set of groups in which each group has two shifted test points.

Three groups are also formed from shifting the five shifted test points in group G2 by shift lengths L1,L2, and L3, respectively. These three groups are groups G2a, G2b, and G2c that are a second set of groups in which each group has five shifted test points. In another example, another three groups of shifted test points 831 is formed from shifting the three shifted test points in group G3. In this illustrative example, these three groups are groups G3a, G3b, and G3c which are referred to as a third set of groups in which each group has three shifted test points.

The average distance of each group of shifted test points to center 821 is determined for each of the nine groups. A group of shifted test points to center 821 is selected from the first set of groups as the selected group of shifted test points to center 821 that has lowest average distance 822 for this first set of groups. A group of shifted test points to center 821 is selected from the second set of groups as the selected group of shifted test points to center 821 that has lowest average distance 822 for this second set of groups. Additionally, a group of shifted test points to center 821 is selected from the third set of groups as the selected group of shifted test points to center 821 that has lowest average distance 822 for this third set of groups.

These three selected groups of shifted test points are used for further processing. The other groups are no longer used and may be discarded.

For example, group G1a with two shifted test points, group G2b with five shifted test points, and group G3b with three shifted test points are the three selected groups having lowest average distance 822 to center 821. Detections of these test points in these groups are used to form new groups of shifted test points 831 based on the quads in which shifted test points 831 are detected in these three selected groups. This grouping is formed such that a group is present for each quad in which shifted test points have been detected for these three selected groups that were selected for further processing.

In this example, these groups were originally generated from shifted test points 831 in which each group was formed using shifted test points detected in the same quad. The shifting of these groups may result in test points ending up in other quads other than the starting quads from these three groups.

For example, the two shifted test points in group G1a are detected in quad Q1. Additionally, two of the five shifted test points in group G2b are detected in quad Q1 and three of the five shifted test points from this group are detected in quad Q2. Also, one of the three shifted test points in group G3b is detected in quad Q3 and one of the three shifted test points are detected in quad Q4 and one of the three shifted test points in this group has reached convergence. In this example, convergence occurs when a test point reaches center 821 or some threshold distance from center 821.

Simulation 801 creates new test groups based on the quads in which the test points are found. In this example, group T is formed from the four shifted test points in quad 1, group U is formed from the five shifted test points in quad Q2, group V is formed from the two shifted test points in quad Q3, and group W is formed from the one shifted test point in quad Q4. Thus, in this example, four groups of shifted test points are formed for further shifting. The one shifted test point from group G3b page convergence is no longer shifted in simulation 801.

The process repeats shifting the groups of shifted test points 831, determining average distances 823, selecting selected groups of shifted test points 831 and creating groups of shifted test points 831 from the selected groups of shifted test points 831 until convergence condition 870 is reached. In this illustrative example, the convergence condition 870 can be present when all or some percentage of shifted test points 831 reach center 821 or are within some threshold distance of center 821. Additionally, convergence condition 870 can be considered to be present when some selected number of shifts have been performed even though not all of shifted test points 831 have reached convergence.

In other examples, convergence condition 870 can comprise at least one of test points 809 reaching convergence or some number of shifts 802 being performed for test points 809. This number of shifts can be, for example, some number of shifts expected for convergence. In yet another example, all of test points 809 are examined. Shifts 802 are selected that minimize the furthest point from center 821. In other words, the measurement is the distance from the center of the quad cell to the test point that is located furthest away from center 821.

In this illustrative example, simulation 801 records the shift lengths from different shift lengths 820 used by the selected groups of shifted test points 831 and are recorded as part of results 850. Additionally, further simulation 801 also records the starting quad from which the shift of a selected group of shifted test points 831 occurs and the subsequent quad in which a detection occurs for shifted test points from a selected group of shifted test points.

Simulation 801 also records information for tree structure 807. This information includes a particular set of shifts 802 where one shift is assigned to each segment. Also, simulation 801 records the number of shift layers required for convergence and the average number of shift layers required.

In this example, simulation 801 creates tree structure 807 that can be used to determine sequence of shifts 272 for use in hybrid 224 in FIG. 2. In this example, only a single tree structure is created in contrast to the many tree structures created by simulation 601 in FIG. 6. The creation of a single tree structure results in evaluating average distances 823 discarding potential branches that do not have lowest average distance 822.

Simulation 801 can result in many of test points 809 reaching convergence condition 870 more quickly in performing shifts 802. However, this simulation may result in being slower to have all of test points 809 reach convergence. As a result, a large number of shifts 802 may result from simulation 801 in selecting sequence of shifts 215 in FIG. 2.

Tree structure 807 has nodes 812 and segments 804 that connect nodes 812 to each other. These nodes and segments define paths 805 through tree structure 807.

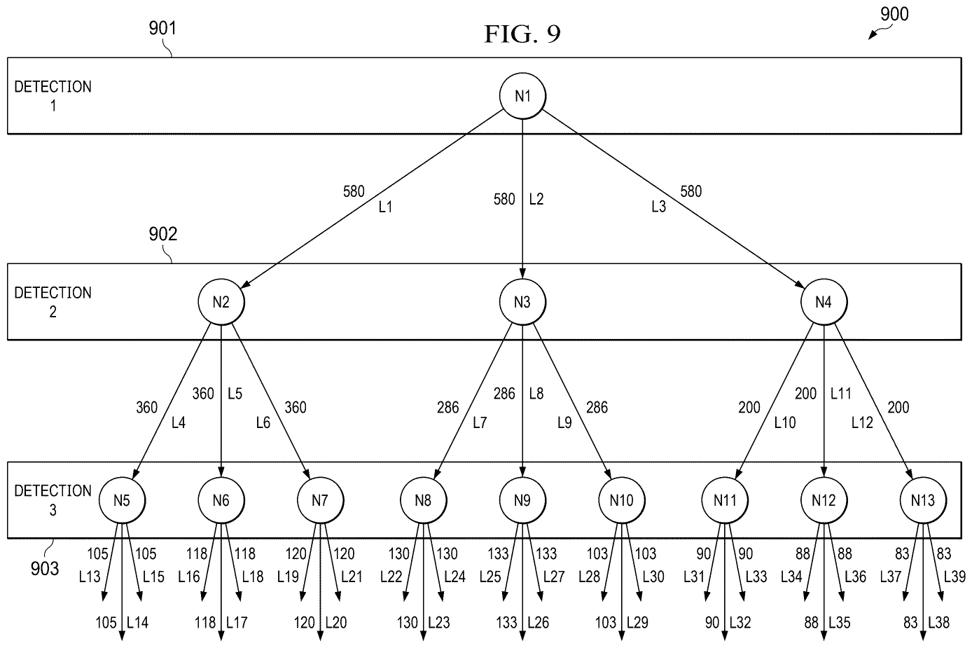

Next in FIG. 9, an illustration of a tree structure is depicted in accordance with an illustrative embodiment. As depicted, tree structure 900 is an example of an implementation for tree structures 606 such as tree structure 607 in FIG. 6 and tree structure 707 in FIG. 7. Tree structure 900 is comprised of nodes and segments. In this example, tree structure 900 includes nodes N1, N2, N3, N4, N5, N6, N7, N8, N9, N10, N11, N12, and N13. Tree structure 900 also includes segments L1, L2, L3, L4, L5, L6, L7, L8, L9, L10, L11, L12, L13, L14, L15, L16, L17, L18, L19, L20, L21, L22, L23, L24, L25, L26, L27, L28, L29, L30, L31, L32, L33, L34, L35, L36, L37, L38, and L39. The segments connect the nodes to each other and these connections of segments form paths for selecting a sequence of shifts to shift a laser beam.

This tree structure is generated from a simulation of shifts and used to identify a sequence of shifts for moving a laser beam to converge on a quad cell sensor.

In this illustrative example, the detection 1 901 for node N1 occurs in quad Q1. Quad Q1 is a starting quad in a quad cell sensor and can be any of the four quads on the quad cell sensor. The other three quads are defined relative to quad Q1. In this example, quad Q3 is directly opposite to quad Q1 across the center of the quad cell sensor. Quad Q2 and quad Q4 are quads adjacent to quad Q1 located on either side of quad Q1.

In the first shift S1, the laser beam is shifted using a shift length of 580 microradians. The segment followed in tree structure 900 by this shift depends on the quad in which detection 2 902 occurs. In this example, node N2 is quad Q1, node N3 is quad Q3,and node N4 is quad Q2 or Q4. For detection 3 903, node N5 is quad Q1; node N6 is quad Q3; node N7 is quad Q2 or Q4; node N8 is quad Q1; node N9 is quad Q3; node N10 is quad Q2 or Q4; node N11 is quad Q1; node N12 is quad Q3; and node N13 is quad Q2 or Q4.

Node N3 is connected to node N6 by segment L4; Node N3 is connected to node N7 by segment L5; and Node N3 is connected to node N8 by segment L6. The shift length for segments L4, L5, and L6 is 360. Node N4 is connected to node N9 by segment L7; Node N4 is connected to node N10 by segment L8; and Node N4 is connected to node N11 by segment L9. The shift length for segments L7, L8, and L9 is 286. Further in this example, node N5 is connected to node N12 by segment L10; Node N5 is connected to node N13 by segment L11; and Node N14 is connected to node N14 by segment L12. The shift length for segments L10, L11, and L12 is 200.

The paths followed by these segments depend on the starting node for the prior shift and the subsequent node after the prior shift. For example, if detection 2 902 detects the laser beam in quad Q3, then segment L2 is followed to node N4.

The next shift, shift S2, is based on the starting quad of the prior shift and the subsequent quad of the prior shift. In this example, the starting quad is quad Q1 in node N1 prior to the first shift S1 and the subsequent quad after the prior shift S1 is quad Q3 in node N4. These detections result in the segment L2 to node N4 being followed in tree structure 900. As a result, shift S2 has a shift length of 286.

In detection 3 903, a quad is identified in response to the second shift S2. In this example, a laser beam is detected in quad Q1.

The next shift S3, has a value based on the segment followed in tree structure 900. In this example, the segment followed is based on the starting quad of the prior shift, shift S2, which is quad 3 in node N4. The subsequent quad of this prior shift is quad Q1 in node N9. Thus, segment L7 is selected for determining the next shift. The segment leads to node N9. Thus, the third shift S3 has a shift length of 130.

The illustration of shifts for a binary variable is presented as a simplified example of how a sequence of shifts can be identified for shifting a laser beam using a tree structure. This example is not meant to limit the manner in which other illustrative examples can implement it. For example, tree structure 900 shows three shifts. In other examples, other numbers of shifts such as five shifts, six shifts, eight shifts, or some other number of shifts can be used in a tree structure to select a sequence of shifts for shifting a laser beam.

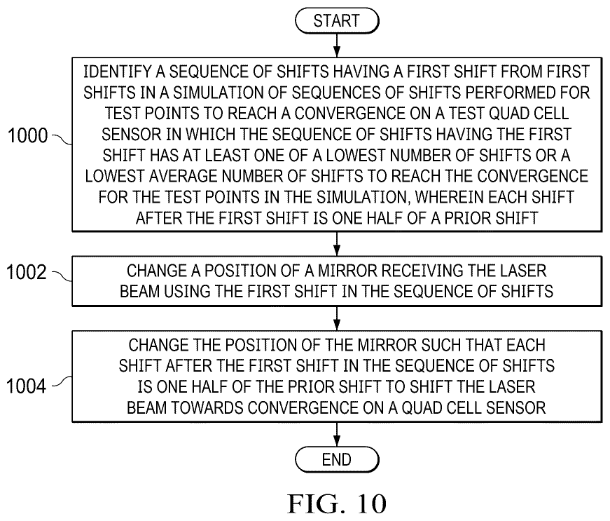

Turning next to FIG. 10, an illustration of a flowchart of a process for converging a laser beam is depicted in accordance with an illustrative embodiment. The process in FIG. 10 can be implemented in hardware, software, or both. When implemented in software, the process can take the form of program instructions that are run by one of more processor units located in one or more hardware devices in one or more computer systems. For example, the process can be implemented in communications controller 214 in computer system 212 in FIG. 2. This process is an example of variable binary 221 in shift processes 227 in FIG. 2.

The process begins by identifying a sequence of shifts having a first shift from first shifts in a simulation of sequences of shifts performed for test points to reach a convergence on a test quad cell sensor in which the sequence of shifts having the first shift has at least one of a lowest number of shifts or a lowest average number of shifts to reach the convergence for the test points in the simulation, wherein each shift after the first shift is one half of a prior shift (operation 1000). The process changes a position of a mirror receiving the laser beam using the first shift in the sequence of shifts to shift the laser beam towards a convergence on a quad cell sensor(operation 1002).

The process changes the position of the mirror such that each shift after the first shift in the sequence of shifts is one half of the prior shift (operation 1004). The process terminates thereafter.

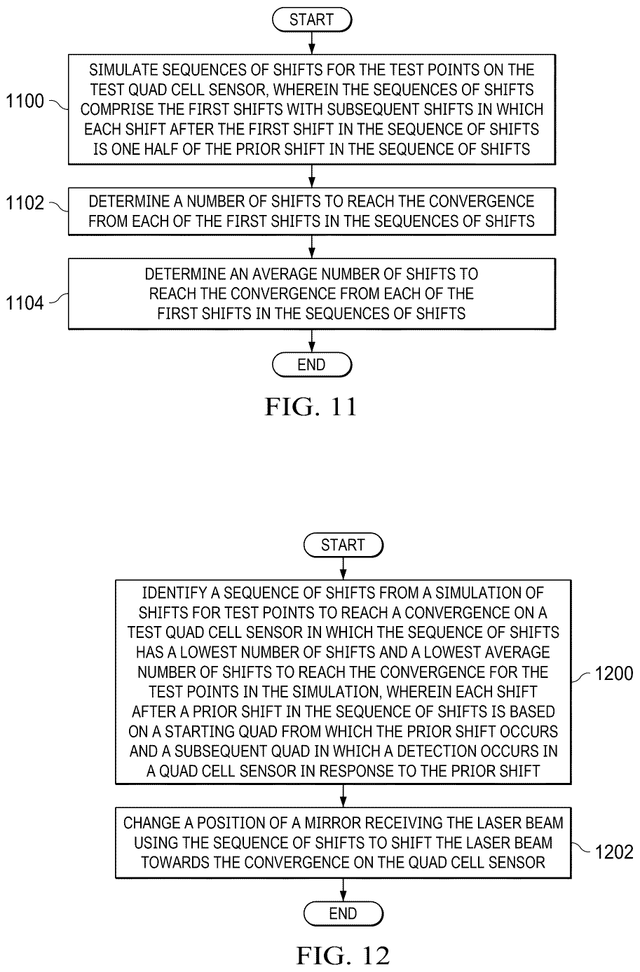

Turning to FIG. 11, an illustration of a flowchart of a process for simulating a sequence of shifts for a laser beam is depicted in accordance with an illustrative embodiment. The process in FIG. 11 can be implemented in hardware, software, or both. When implemented in software, the process can take the form of program instructions that are run by one of more processor units located in one or more hardware devices in one or more computer systems. For example, the process can be implemented in simulator 600 in FIG. 6.

The process simulates sequences of shifts for the test points on the test quad cell sensor, wherein the sequences of shifts comprise the first shifts with subsequent shifts in which each shift after the first shift in the sequence of shifts is one half of the prior shift in the sequence of shifts (operation 1100). The process determines a number of shifts to reach the convergence from each of the first shifts in the sequences of shifts (operation 1102).

The process determines an average number of shifts to reach the convergence from each of the first shifts in the sequences of shifts (operation 1104). The process terminates thereafter.

Turning next to FIG. 12, an illustration of a flowchart of a process for converging a laser beam is depicted in accordance with an illustrative embodiment. The process in FIG. 12 can be implemented in hardware, software, or both. When implemented in software, the process can take the form of program instructions that are run by one of more processor units located in one or more hardware devices in one or more computer systems. For example, the process can be implemented in communications controller 214 in computer system 212 in FIG. 2. This process is an example of split binary 222 in shift processes 227 in FIG. 2.

The process begins by identifying a sequence of shifts from a simulation of shifts for test points to reach a convergence on a test quad cell sensor in which the sequence of shifts has a lowest number of shifts and a lowest average number of shifts to reach the convergence for the test points in the simulation, wherein each shift after a prior shift in the sequence of shifts is based on a starting quad from which the prior shift occurs and a subsequent quad in which a detection occurs in response to the prior shift (operation 1200).

In operation 1200, the sequence of shifts are in a tree structure resulting from the simulation with paths of shifts in which a shift in the sequence of shifts is selected from the shifts in the tree structure based on the starting quad from which the prior shift to the shift occurs and the subsequent quad in which a detection occurs in response to the prior shift. This tree structure can be one tree structure in multiple tree structures generated by the simulation of the test points that have at least one of a lowest number of shifts or a lowest average number of shifts to reach convergence.

The process changes a position of a mirror receiving the laser beam using the sequence of shifts to shift the laser beam towards the convergence on a quad cell sensor (operation 1202). The process terminates thereafter.

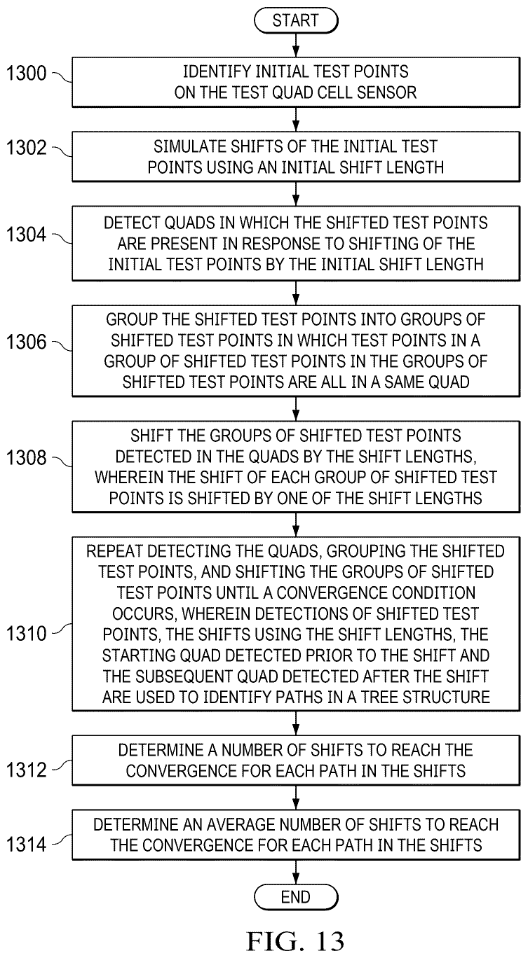

Referring to FIG. 13, an illustration of a flowchart of a process for simulating a shift for a laser beam is depicted in accordance with an illustrative embodiment. The process in FIG. 13 can be implemented in hardware, software, or both. When implemented in software, the process can take the form of program instructions that are run by one of more processor units located in one or more hardware devices in one or more computer systems. For example, the process can be implemented in simulator 600 in FIG. 6.

The process begins by identifying initial test points on the test quad cell sensor (operation 1300). These test points can be determined in a number of different ways. For example, the test points can be randomly selected. In another example, the test points can be determined using a Gaussian probability distribution function to identify where test points will be located on the quad cell sensor. With this distribution, more test points are located closer to the center of the quad cell sensor.

The process simulates shifts of the initial test points using an initial shift length (operation 1302). The process detects quads in which the shifted test points are present in response to shifting of the initial test points by the initial shift length (operation 1304).

The process groups the shifted test points into groups of shifted test points in which test points in a group of shifted test points in the groups of shifted test points are all in a same quad (operation 1306). The process shifts the groups of shifted test points detected in the quads by the shift lengths, wherein the shift of each group of shifted test points is shifted by one of the shift lengths (operation 1308). The process repeats detecting the quads, grouping the shifted test points, and shifting the groups of shifted test points until a convergence condition occurs, wherein detections of shifted test points, the shifts using the shift lengths, the starting quad detected prior to the shift and the subsequent quad detected after the shift are used to identify paths in a tree structure (operation 1310).

The process determines a number of shifts to reach the convergence for each path in the shifts (operation 1312). The process determines an average number of shifts to reach the convergence for each path in the shifts (operation 1314). The process terminates thereafter.

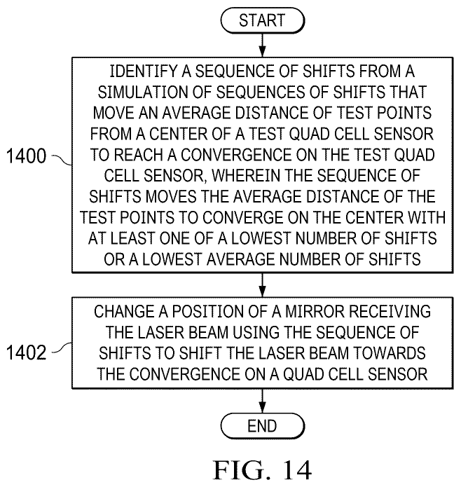

With reference to FIG. 14, an illustration of a flowchart of a process for converging a laser beam is depicted in accordance with an illustrative embodiment. The process in FIG. 14 can be implemented in hardware, software, or both. When implemented in software, the process can take the form of program instructions that are run by one of more processor units located in one or more hardware devices in one or more computer systems. For example, the process can be implemented in communications controller 214 in computer system 212 in FIG. 2. This process is an example of minimum average distance 223 in shift processes 227 in FIG. 2.

The process begins by identifying a sequence of shifts from a simulation of sequences of shifts that move an average distance of test points from a center of a test quad cell sensor to reach a convergence on the test quad cell sensor, wherein the sequence of shifts moves the average distance of the test points to converge on the center with at least one of a lowest number of shifts or a lowest average number of shifts (operation 1400). In operation 1400, the sequence of shifts can be identified from the sequence of shifts resulting from simulations of sequences of shifts. In some examples, the sequence of shifts moves the average distance of the test points to converge on the center with at least one of a lowest number of shifts or a lowest average number of shifts.

The process changes a position of a mirror receiving the laser beam using the sequence of shifts to shift the laser beam towards the convergence on a quad cell sensor (operation 1402). The process terminates thereafter.

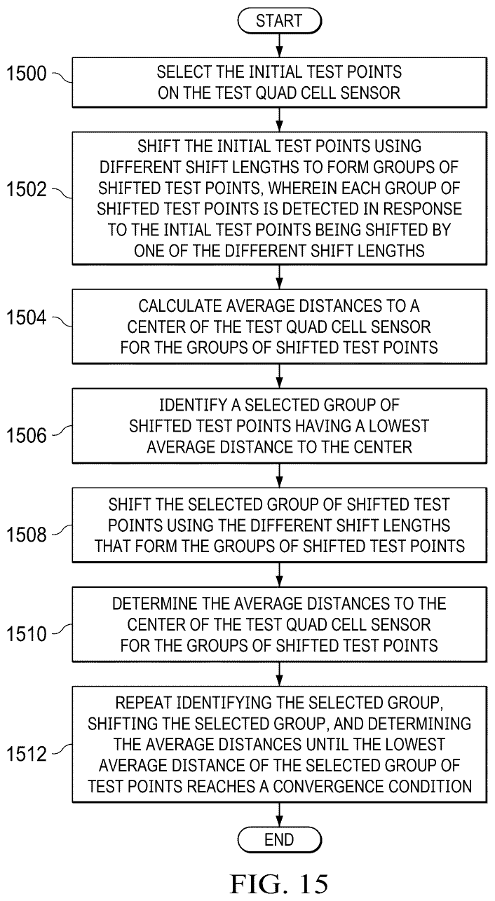

Next in FIG. 15, an illustration of a flowchart of a process for simulating a shift for a laser beam is depicted in accordance with an illustrative embodiment. The process in FIG. 15 can be implemented in hardware, software, or both. When implemented in software, the process can take the form of program instructions that are run by one of more processor units located in one or more hardware devices in one or more computer systems. For example, the process can be implemented in simulator 700 in FIG. 7.

The process selects the initial test points on the test quad cell sensor (operation 1500). The process shifts the initial test points using different shift lengths to form groups of shifted test points, wherein each group of shifted test points is detected in response to the initial test points being shifted by one of the different shift lengths (operation 1502). The process calculates average distances to a center of the test quad cell sensor for the groups of shifted test points (operation 1504).

The process identifies a selected group of shifted test points having a lowest average distance to the center (operation 1506). The process shifts the selected group of shifted test points using the different shift lengths that form the groups of shifted test points (operation 1508). The process determines the average distances to the center of the test quad cell sensor for the groups of shifted test points (operation 1510).

The process repeats identifying the selected group, shifting the selected group, and determining the average distances until the lowest average distance of the selected group of test points reaches a convergence condition (operation 1512). The process terminates thereafter.

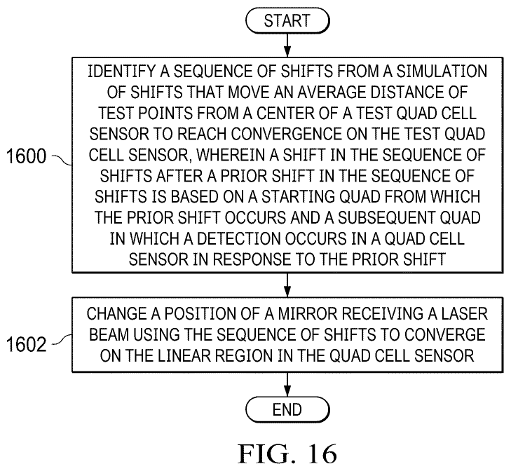

With reference to FIG. 16, an illustration of a flowchart of a process for converging a laser beam is depicted in accordance with an illustrative embodiment. The process in FIG. 16 can be implemented in hardware, software, or both. When implemented in software, the process can take the form of program instructions that are run by one of more processor units located in one or more hardware devices in one or more computer systems. For example, the process can be implemented in communications controller 214 in computer system 212 in FIG. 2. This process is an example of hybrid 224 in shift processes 227 in FIG. 2.

The process identifies a sequence of shifts from a simulation of shifts that move an average distance of test points from a center of a test quad cell sensor to reach convergence on the test quad cell sensor, wherein a shift in the sequence of shifts after a prior shift in the sequence of shifts is based on a starting quad from which the prior shift occurs and a subsequent quad in which a detection occurs in a quad cell sensor in response to the prior shift (operation 1600). In operation 1600, the sequence of shifts can be identified in a tree structure resulting from the simulations. The sequence of shifts are in a tree structure resulting from the simulation with paths of shifts in which a shift in the sequence of shifts is selected from the shifts in the tree structure based on the starting quad from which the prior shift to the shift occurs and the subsequent quad in which a detection occurs in response to the prior shift.

The process changes a position of a mirror receiving a laser beam using the sequence of shifts to converge the laser beam on the linear region in the quad cell sensor (operation 1602). The process terminates thereafter.

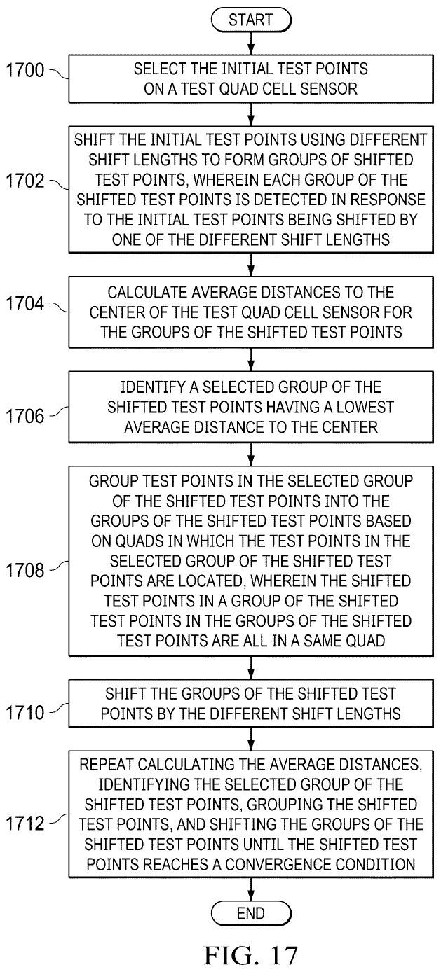

Turning to FIG. 17, an illustration of a flowchart of a process for simulating a shift for a laser beam is depicted in accordance with an illustrative embodiment. The process in FIG. 17 can be implemented in hardware, software, or both. When implemented in software, the process can take the form of program instructions that are run by one of more processor units located in one or more hardware devices in one or more computer systems. For example, the process can be implemented in simulator 800 in FIG. 8.

The process selects the initial test points on a test quad cell sensor (operation 1700). The process shifts the initial test points using different shift lengths to form groups of shifted test points, wherein each group of the shifted test points is detected in response to the initial test points being shifted by one of the different shift lengths (operation 1702).

The process calculates average distances to the center of the test quad cell sensor for the groups of the shifted test points (operation 1704). The process identifies a selected group of the shifted test points having a lowest average distance to the center (operation 1706).

The process groups of test points in the selected group of shifted test points into the groups of the shifted test points based on quads in which the shifted test points in the selected group of the shifted test points are located, wherein the shifted test points in a group of the shifted test points in the groups of shifted test points are all in a same quad (operation 1708). The process shifts the groups of the shifted test points by the different shift lengths (operation 1710).

The process repeats calculating the average distances, identifying the selected group of the shifted test points, grouping the shifted test points, and shifting the groups of the shifted test points until the shifted test points reaches a convergence condition (operation 1712). The process terminates thereafter.

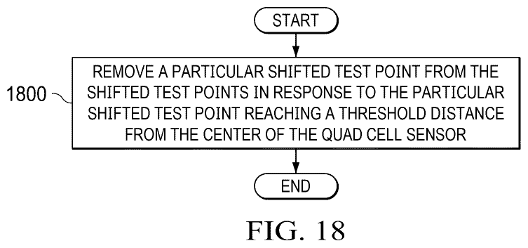

Next in FIG. 18, an illustration of a flowchart of a process for simulating shifts of a laser beam is depicted in accordance with an illustrative embodiment. The operation in this flowchart is an example of an additional operation that can be performed with the operations in the flowchart illustrated in at least one of FIG. 15, FIG. 16, and FIG. 17.

The process removes a particular shifted test point from the shifted test points in response to the particular shifted test point reaching a threshold distance from the center of the test quad cell sensor (operation 1800). The process terminates thereafter.

The flowcharts and block diagrams in the different depicted embodiments illustrate the architecture, functionality, and operation of some possible implementations of apparatuses and methods in an illustrative embodiment. In this regard, each block in the flowcharts or block diagrams can represent at least one of a module, a segment, a function, or a portion of an operation or step. For example, one or more of the blocks can be implemented as program instructions, hardware, or a combination of the program instructions and hardware. When implemented in hardware, the hardware can, for example, take the form of integrated circuits that are manufactured or configured to perform one or more operations in the flowcharts or block diagrams. When implemented as a combination of program instructions and hardware, the implementation may take the form of firmware. Each block in the flowcharts or the block diagrams can be implemented using special purpose hardware systems that perform the different operations or combinations of special purpose hardware and program instructions run by the special purpose hardware.

In some alternative implementations of an illustrative embodiment, the function or functions noted in the blocks may occur out of the order noted in the figures. For example, in some cases, two blocks shown in succession may be performed substantially concurrently, or the blocks may sometimes be performed in the reverse order, depending upon the functionality involved. Also, other blocks may be added in addition to the illustrated blocks in a flowchart or block diagram.

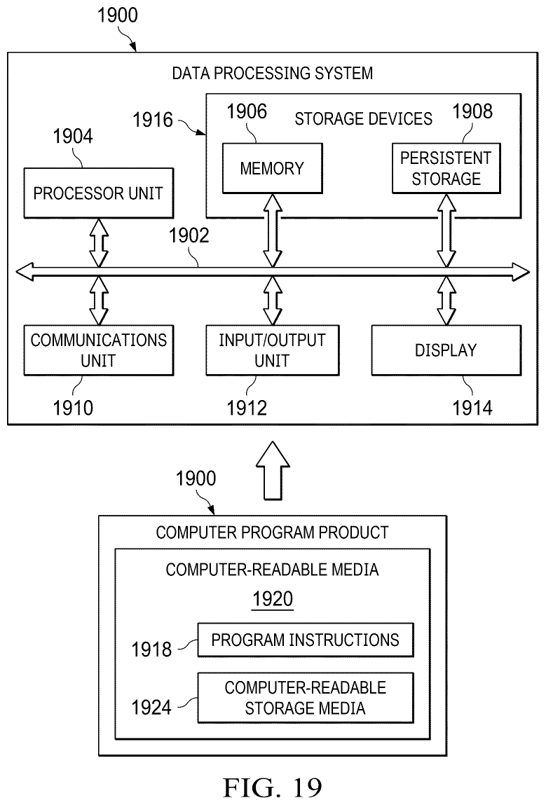

Turning now to FIG. 19, a block diagram of a data processing system is depicted in accordance with an illustrative embodiment. Data processing system 1900 can be used to implement computer system 212 in FIG. 2. In this illustrative example, data processing system 1900 includes communications framework 1902, which provides communications between processor unit 1904, memory 1906, persistent storage 1908, communications unit 1910, input/output (I/O) unit 1912, and display 1914. In this example, communications framework 1902 takes the form of a bus system.

Processor unit 1904 serves to execute instructions for software that can be loaded into memory 1906. Processor unit 1904 includes one or more processors. For example, processor unit 1904 can be selected from at least one of a multicore processor, a central processing unit (CPU), a graphics processing unit (GPU), a physics processing unit (PPU), a digital signal processor (DSP), a network processor, or some other suitable type of processor. Further, processor unit 1904 can be implemented using one or more heterogeneous processor systems in which a main processor is present with secondary processors on a single chip. As another illustrative example, processor unit 1904 can be a symmetric multi-processor system containing multiple processors of the same type on a single chip.

Memory 1906 and persistent storage 1908 are examples of storage devices 1916. A storage device is any piece of hardware that is capable of storing information, such as, for example, without limitation, at least one of data, program instructions in functional form, or other suitable information either on a temporary basis, a permanent basis, or both on a temporary basis and a permanent basis. Storage devices 1916 may also be referred to as computer-readable storage devices in these illustrative examples. Memory 1906, in these examples, can be, for example, a random-access memory or any other suitable volatile or non-volatile storage device. Persistent storage 1908 may take various forms, depending on the particular implementation.

For example, persistent storage 1908 may contain one or more components or devices. For example, persistent storage 1908 can be a hard drive, a solid-state drive (SSD), a flash memory, a rewritable optical disk, a rewritable magnetic tape, or some combination of the above. The media used by persistent storage 1908 also can be removable. For example, a removable hard drive can be used for persistent storage 1908.

Communications unit 1910, in these illustrative examples, provides for communications with other data processing systems or devices. In these illustrative examples, communications unit 1910 is a network interface card.

Input/output unit 1912 allows for input and output of data with other devices that can be connected to data processing system 1900. For example, input/output unit 1912 may provide a connection for user input through at least one of a keyboard, a mouse, or some other suitable input device. Further, input/output unit 1912 may send output to a printer. Display 1914 provides a mechanism to display information to a user.

Instructions for at least one of the operating system, applications, or programs can be located in storage devices 1916, which are in communication with processor unit 1904 through communications framework 1902. The processes of the different embodiments can be performed by processor unit 1904 using computer-implemented instructions, which may be located in a memory, such as memory 1906.

These instructions are referred to as program instructions, computer usable program instructions, or computer-readable program instructions that can be read and executed by a processor in processor unit 1904. The program instructions in the different embodiments can be embodied on different physical or computer-readable storage media, such as memory 1906 or persistent storage 1908.

Program instructions 1918 are located in a functional form on computer-readable media 1920 that is selectively removable and can be loaded onto or transferred to data processing system 1900 for execution by processor unit 1904. Program instructions 1918 and computer-readable media 1920 form computer program product 1922 in these illustrative examples. In the illustrative example, computer-readable media 1920 is computer-readable storage media 1924.

Computer-readable storage media 1924 is a physical or tangible storage device used to store program instructions 1918 rather than a medium that propagates or transmits program instructions 1918. Computer-readable storage media 1924 may be at least one of an electronic storage medium, a magnetic storage medium, an optical storage medium, an electromagnetic storage medium, a semiconductor storage medium, a mechanical storage medium, or other physical storage medium. Some known types of storage devices that include these mediums include: a diskette, a hard disk, a random access memory (RAM), a read-only memory (ROM), an erasable programmable read-only memory (EPROM or Flash memory), a static random access memory (SRAM), a compact disc read-only memory (CD-ROM), a digital versatile disk (DVD), a memory stick, a floppy disk, a mechanically encoded device, such as punch cards or pits / lands formed in a major surface of a disc, or any suitable combination thereof.

Computer-readable storage media 1924, as that term is used in the present disclosure, is not to be construed as storage in the form of transitory signals per se, such as at least one of radio waves or other freely propagating electromagnetic waves, electromagnetic waves propagating through a waveguide, light pulses passing through a fiber optic cable, electrical signals communicated through a wire, or other transmission media.

Further, data can be moved at some occasional points in time during normal operations of a storage device. These normal operations include access, de-fragmentation or garbage collection. However, these operations do not render the storage device as transitory because the data is not transitory while the data is stored in the storage device.

Alternatively, program instructions 1918 can be transferred to data processing system 1900 using a computer-readable signal media. The computer-readable signal media are signals and can be, for example, a propagated data signal containing program instructions 1918. For example, the computer-readable signal media can be at least one of an electromagnetic signal, an optical signal, or any other suitable type of signal. These signals can be transmitted over connections, such as wireless connections, optical fiber cable, coaxial cable, a wire, or any other suitable type of connection.

Further, as used herein, “computer-readable media 1920” can be singular or plural. For example, program instructions 1918 can be located in computer-readable media 1920 in the form of a single storage device or system. In another example, program instructions 1918 can be located in computer-readable media 1920 that is distributed in multiple data processing systems. In other words, some instructions in program instructions 1918 can be located in one data processing system while other instructions in program instructions 1918 can be located in one data processing system. For example, a portion of program instructions 1918 can be located in computer-readable media 1920 in a server computer while another portion of program instructions 1918 can be located in computer-readable media 1920 located in a set of client computers.

The different components illustrated for data processing system 1900 are not meant to provide architectural limitations to the manner in which different embodiments can be implemented. In some illustrative examples, one or more of the components may be incorporated in or otherwise form a portion of, another component. For example, memory 1906, or portions thereof, may be incorporated in processor unit 1904 in some illustrative examples. The different illustrative embodiments can be implemented in a data processing system including components in addition to or in place of those illustrated for data processing system 1900. Other components shown in FIG. 19 can be varied from the illustrative examples shown. The different embodiments can be implemented using any hardware device or system capable of running program instructions 1918.

The description of the different illustrative embodiments has been presented for purposes of illustration and description and is not intended to be exhaustive or limited to the embodiments in the form disclosed. The different illustrative examples describe components that perform actions or operations. In an illustrative embodiment, a component can be configured to perform the action or operation described. For example, the component can have a configuration or design for a structure that provides the component an ability to perform the action or operation that is described in the illustrative examples as being performed by the component. Further, to the extent that terms “includes”, “including”, “has”, “contains”, and variants thereof are used herein, such terms are intended to be inclusive in a manner similar to the term “comprises” as an open transition word without precluding any additional or other elements.

Many modifications and variations will be apparent to those of ordinary skill in the art. Further, different illustrative embodiments may provide different features as compared to other desirable embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

What is claimed is:

1. A method for converging a laser beam, the method comprising:
identifying a sequence of shifts from a simulation of sequences of shifts that move an average distance of test points from a center of a test quad cell sensor to reach a convergence on the test quad cell sensor, wherein a shift in the sequence of shifts after a prior shift in the sequence of shifts is based on a starting quad from which the prior shift occurs and a subsequent quad in which a detection occurs in a quad cell sensor in response to the prior shift; and
changing a position of a mirror receiving the laser beam using the sequence of shifts to converge on the center of the quad cell sensor.

2. The method of claim 1, wherein the convergence is at the center of quad cell sensor.

3. The method of claim 1, wherein the convergence is within a threshold distance from the center of the quad cell sensor.

4. The method of claim 1, wherein the sequence of shifts are in a tree structure resulting from the simulation with paths of shifts in which the shift in the sequence of shifts is selected from the shifts in the tree structure based on the starting quad from which the prior shift to the shift occurs and the subsequent quad in which a detection occurs in response to the prior shift.

5. The method of claim 1, wherein shifts in the sequence of shifts are angular shifts of the laser beam.

6. The method of claim 1, wherein each shift is in a direction away from an outer edge of a quad in which the laser beam is detected.

7. The method of claim 1, wherein the mirror is a fast steering mirror that rotates to shift where the laser beam is directed to on the quad cell sensor.

8. The method of claim 1, wherein the quad cell sensor and the mirror are located in a communications terminal selected from at least one of a mobile platform, a stationary platform, a land-based structure, an aquatic-based structure, a space-based structure, a surface ship, a tank, a personnel carrier, a train, a spacecraft, a space station, a satellite, a high altitude platform system (HAPS), a submarine, an automobile, a power plant, a bridge, a dam, a house, a manufacturing facility, a drone, or a building.

9. The method of claim 1 further comprising:
selecting initial test points on the test quad cell sensor;
shifting the initial test points using different shift lengths to form groups of shifted test points, wherein each group of the shifted test points is detected in response to the initial test points being shifted by one of the different shift lengths;
calculating average distances to the center of the test quad cell sensor for the groups of the shifted test points;
identifying a selected group of the shifted testing points having a lowest average distance to the center;
grouping test points in the selected group of the shifted test points into the groups of the shifted test points based on quads in which the shifted test points in the selected group of the shifted test points are located, wherein the test points in a group of the shifted test points in the groups of the shifted test points are all in a same quad;
shifting the groups of the shifted test points by the different shift lengths; and
repeating calculating the average distances, identifying the selected group of the shifted test points, grouping the shifted test points, and shifting the groups of the shifted test points until the shifted test points reaches a convergence condition.

10. The method of claim 9 further comprising:
removing a particular shifted test point from the groups of shifted test points in response to the particular shifted test point reaching a threshold distance from the center of the test quad cell sensor.

11. A communications terminal comprising:
a quad cell sensor;
a mirror that directs a laser beam received by the communications terminal to the quad cell sensor; and
a communications controller configured to perform operations comprising:
identifying a sequence of shifts from a simulation of sequences of shifts that move an average distance of test points from a center of a test quad cell sensor to reach a convergence on the test quad cell sensor, wherein a shift in the sequence of shifts after a prior shift in the sequence of shifts is based on a starting quad from which the prior shift occurs and a subsequent quad in which a detection occurs in the quad cell sensor in response to the prior shift; and
changing a position of a mirror receiving the laser beam using the sequence of shifts to converge on the center of the quad cell sensor.

12. The communications terminal of claim 11, wherein the convergence is at the center of the quad cell sensor.

13. The communications terminal of claim 11, wherein the convergence is within a threshold distance from the center of the quad cell sensor.

14. The communications terminal of claim 11, wherein the sequence of shifts are in a tree structure resulting from the simulation with paths of shifts in which the shift in the sequence of shifts is selected from the shifts in the tree structure based on the starting quad from which the prior shift to the shift occurs and the subsequent quad in which a detection occurs in response to the prior shift.

15. The communications terminal of claim 11, wherein shifts in the sequence of shifts are angular shifts of the laser beam.

16. The communications terminal of claim 11, wherein each shift is in a direction away from an outer edge of a quad in which the laser beam is detected.

17. The communications terminal of claim 11, wherein the mirror is a fast steering mirror that rotates to shift where the laser beam is directed to on the quad cell sensor.

18. The communications terminal of claim 11, wherein the quad cell sensor and the mirror are located in a communications terminal selected from at least one of a mobile platform, a stationary platform, a land-based structure, an aquatic-based structure, a space-based structure, a surface ship, a tank, a personnel carrier, a train, a spacecraft, a space station, a satellite, a high altitude platform system (HAPS), a submarine, an automobile, a power plant, a bridge, a dam, a house, a manufacturing facility, a drone, or a building.

19. The communications terminal of claim 11 further comprising:
a simulator configured to perform operations comprising:
selecting initial test points on the test quad cell sensor;
shifting the initial test points using different shift lengths to form groups of shifted test points, wherein each group of the shifted test points is detected in response to the initial test points being shifted by one of the different shift lengths;
calculating average distances to the center of the test quad cell sensor for the groups of the shifted test points;
identifying a selected group of the shifted testing points having a lowest average distance to the center;
grouping test points in the selected group of the shifted test points into the groups of the shifted test points based on quads in which the shifted test points in the selected group of the shifted test points are located, wherein the test points in a group of the shifted test points in the groups of the shifted test points are all in a same quad;
shifting the groups of the shifted test points by the different shift lengths; and
repeating calculating the average distances, identifying the selected group of the shifted test points, grouping the shifted test points, and shifting the groups of the shifted test points until the shifted test points reaches a convergence condition.

20. The communications terminal of claim 19, wherein the operations further comprise:
removing a particular shifted test point from the groups of shifted test points in response to the particular shifted test point reaching a threshold distance from the center of the quad cell sensor.

21. A computer program product for converging a laser beam, the computer program product comprising:
a set of one or more computer-readable storage media;
program instructions stored on the set of one or more storage media to perform operations comprising:
identifying a sequence of shifts from a simulation of sequences of shifts that move an average distance of test points from a center of a test quad cell sensor to reach a convergence on the test quad cell sensor, wherein a shift in the sequence of shifts after a prior shift in the sequence of shifts is based on a starting quad from which the prior shift occurs and a subsequent quad in which a detection occurs in a quad cell sensor in response to the prior shift; and
changing a position of a mirror receiving the laser beam using the sequence of shifts to converge on the center of the quad cell sensor.
